(19) United States
(12) Patent Application Publication
(10) Pub. No.: US 2017/0137642 A1
(43) Pub. Date: May 18, 2017

(54) ULTRAVIOLET-CURABLE COMPOSITION AND RECORDED MATTER

(71) Applicant: Seiko Epson Corporation, Tokyo (JP)

(72) Inventors: Hiroshi TAKIGUCHI, Matsumoto (JP); Keitaro NAKANO, Matsumoto (JP); Yoshiyuki SUZUKI, Matsumoto (JP)

(21) Appl. No.: 15/342,508

(22) Filed: Nov. 3, 2016

(30) Foreign Application Priority Data
Nov. 17, 2015 (JP) 2015-224704

(51) Int. Cl. C09D 11/101; C09D 11/03; C09D 11/32

(52) U.S. Cl. CPC C09D 11/101; C09D 11/32; C09D 11/03

(57) ABSTRACT

An ultraviolet-curable composition includes a polymerizable compound; a metal powder; and a dendritic polymer which contains a fluorine atom. The average particle diameter of the dendritic polymer is preferably 2 nm to 20 nm. In addition, the dendritic polymer preferably has an acrylic skeleton. The average particle diameter of the metal powder is preferably 200 nm to 3.0 μm.

### BACKGROUND

1. Technical Field

The present invention relates to an ultraviolet-curable composition and recorded matter.

2. Related Art

In the background art, as methods for manufacturing ornaments which have glossiness, metal plating, stamping printing using a metal foil, thermal transfer using a metal foil, and the like are used.

However, there is a problem with these methods in that fine pattern formation and application to curved portions are difficult.

On the other hand, a recording method in which a composition including a pigment or dye is applied to a recording medium by a method such as an ink jet method is used. This method is excellent in the points that fine pattern formation is possible and that suitable application for recording on curved portions is also possible. In addition, in recent years, compositions which are cured when irradiated with ultraviolet rays (ultraviolet-curable compositions) have been used (for example, refer to JP-A-2009-57548) in order to obtain particularly excellent abrasion resistance, water resistance, solvent resistance, and the like.

However, in ultraviolet-curable compositions, in a case of simply applying a metal powder instead of a pigment or dye, there is a problem in that it is not possible to sufficiently exhibit characteristics such as the natural glossiness of the metal and, in addition, problems are caused such as deterioration in the stability (storage stability) of the composition and decreases in the discharge stability due to increased viscosity due to gelling. In addition, in a case of using a composition which includes a metal powder, there is a problem in that the changes in the external appearance due to friction are great in comparison with a case of using a composition which includes a pigment or a dye.

### SUMMARY

An advantage of some aspects of the invention is to provide an ultraviolet-curable composition which is excellent in storage stability and which can be favorably used to form a pattern (a printed portion) with excellent glossiness and abrasion resistance, and also to provide recorded matter which has a pattern with excellent glossiness and abrasion resistance formed using the ultraviolet-curable composition.

The invention has adopted the following.

According to an aspect of the invention, an ultraviolet-curable composition includes a polymerizable compound, a metal powder, and a dendritic polymer which contains a fluorine atom.

Due to this, it is possible to provide an ultraviolet-curable composition which is excellent in storage stability and which can be favorably used in the forming of a pattern (a printed portion) with excellent glossiness and abrasion resistance.

In the ultraviolet-curable composition according to the aspect of the invention, the average particle diameter of the dendritic polymer is preferably 2 nm to 20 nm.

Due to this, it is possible to make the glossiness and aesthetics (aesthetic external appearance) of the printed portion formed using the ultraviolet-curable composition particularly excellent and to make the abrasion resistance of the printed portion particularly excellent.

In the ultraviolet-curable composition according to the aspect of the invention, the dendritic polymer preferably has an acrylic skeleton.

Due to this, it is possible to make the aesthetics (aesthetic external appearance) of the recorded matter in the printed portion particularly excellent. In addition, it is possible to make the abrasion resistance, the film strength, and the like of the printed portion particularly excellent.

In the ultraviolet-curable composition according to the aspect of the invention, the constituent particles of the metal powder are preferably flaky.

Due to this, it is possible to make the glossiness and sense of luxury of a formed pattern (a printed portion) particularly excellent.

In the ultraviolet-curable composition according to the aspect of the invention, the average thickness of the constituent particles of the metal powder is preferably 10 nm to 80 nm.

Due to this, it is possible to make the glossiness and sense of luxury of the formed pattern (the printed portion) superior.

In the ultraviolet-curable composition according to the aspect of the invention, the average thickness of the constituent particles of the metal powder is preferably greater than the average particle diameter of the dendritic polymer.

Due to this, it is possible to make the glossiness of the printed portion formed using the ultraviolet-curable composition superior.

In the ultraviolet-curable composition according to the aspect of the invention, the average particle diameter of the metal powder is preferably 200 nm to 3.0 μm.

Due to this, it is possible to make the glossiness and sense of luxury of the recorded matter produced using the ultraviolet-curable composition superior. In addition, it is possible to make the storage stability and discharge stability of the ultraviolet-curable composition superior.

In the ultraviolet-curable composition according to the aspect of the invention, a monomer which has an alicyclic structure is preferably included as the polymerizable compound.

Due to this, it is possible to make the storage stability and discharge stability of the ultraviolet-curable composition particularly excellent and it is also possible to make the glossiness and abrasion resistance of the printed portion of the recorded matter produced using the ultraviolet-curable composition particularly excellent.

In the ultraviolet-curable composition according to the aspect of the invention, the monomer having an alicyclic structure preferably includes one or more types selected from a group formed of tris(2-acryloyloxyethyl) isocyanurate, dicyclopentenyloxyethyl acrylate adamantyl acrylate, γ-butyrolactone acrylate, N-vinylcaprolactam, N-vinylpyrrolidone, pentamethyl piperidylacrylate, tetramethylpiperidyl acrylate, 2-methyl-2-adamantyl acrylate, 2-ethyl-2-adamantyl acrylate, mevalonic lactone acrylate, dimethylol tricyclodecane acrylate, dimethylol dicyclopentane diacrylate, dicyclo dipentenyl acrylate, dicyclo pentanyl acrylate, isobornyl acrylate, cyclohexyl acrylate, acryloylmorpholine, tetrahydrofurfuryl acrylate, cyclohexane spiro-2-(1,3-dioxolan-4-yl) methyl acrylate, (2-methyl-2-ethyl-1,3-dioxolan-4-yl) methyl acrylate, and cyclic trimethylolpropane formal acrylate.

Due to this, it is possible to make the glossiness and sense of luxury of the recorded matter produced using the ultraviolet-curable composition superior. In addition, it is possible to make the storage stability and discharge stability of the ultraviolet-curable composition superior.

In the ultraviolet-curable composition of the invention, one type or or two or more types selected from a group formed of phenoxyethyl acrylate, benzyl acrylate, 2-(2-vinyloxy ethoxy) ethyl acrylate, dipropylene glycol diacrylate, tripropylene glycol diacrylate, 2-hydroxy-3-phenoxypropyl acrylate, and 4-hydroxybutyl acrylate are preferably included as the polymerizable compound other than the monomer having an alicyclic structure.

Due to this, it is possible to make the reactivity of the ultraviolet-curable composition after discharge with the ink jet method particularly excellent while making the storage stability and discharge stability of the ultraviolet-curable composition excellent, to make the productivity of the recorded matter particularly excellent, and to make the abrasion resistance and the like of the formed patterns particularly excellent.

According to another aspect of the invention, the recorded matter is provided with a cured product of the ultraviolet-curable composition of the aspect described above, and a recording medium.

Due to this, it is possible to provide the recorded matter which has a pattern with excellent glossiness and abrasion resistance.

### DESCRIPTION OF EXEMPLARY EMBODIMENTS

Detailed description will be given below of favorable embodiments of the invention.

### Ultraviolet-Curable Composition

First, description will be given of the ultraviolet-curable composition of the invention.

The ultraviolet-curable composition of the invention includes a polymerizable compound which is polymerized by being irradiated with ultraviolet rays, and a metal powder.

Here, in the background art, metal plating, stamping printing using a metal foil, thermal transfer using a metal foil, and the like are used as methods for manufacturing ornaments which have glossiness.

However, there is a problem with these methods in that fine pattern formation and application to curved portions are difficult.

On the other hand, a recording method in which a composition including a pigment or dye is applied to a recording medium with a method such as an ink jet method can be used. This method is excellent in the points that fine pattern formation is possible and that suitable application for recording on curved portions is also possible. In addition, compositions which are cured when irradiated with ultraviolet rays (ultraviolet-curable compositions) have been used in recent years in order to obtain particularly excellent abrasion resistance, water resistance, solvent resistance, and the like.

However, in ultraviolet-curable compositions, in a case of simply applying a metal powder instead of a pigment or dye, there is a problem in that it is not possible to sufficiently exhibit characteristics such as the natural glossiness of the metal and, in addition, problems are caused such as deterioration in the stability (storage stability) of the composition and decreases in the discharge stability due to increased viscosity due to gelling. In addition, in a case of using a composition which includes a metal powder, there is a problem in that the changes in the external appearance due to friction are great in comparison with a case of using a composition which includes a pigment or a dye.

Thus, the present inventors completed the invention as a result of intensive research for the purpose of solving the problem described above. That is, the ultraviolet-curable composition of the invention further includes a dendritic polymer which contains a fluorine atom in addition to the polymerizable compound, and metal powder. Due to this, the dispersion stability of the metal powder in the ultraviolet-curable composition is excellent and it is possible to make the storage stability of the ultraviolet-curable composition and the discharge stability over long periods excellent. In addition, in the recorded matter produced using the ultraviolet-curable composition, it is possible to suitably array the metal powder in the vicinity of the outer surface of the printed portion and to sufficiently exhibit the natural glossiness and the like of the metal material which forms the metal powder. In addition, it is also possible to suitably arrange the metal powder and the dendritic polymer (fluorine-containing powder) which contains the fluorine atom in the vicinity of the outer surface of the printed portion, the abrasion resistance of the printed portion is excellent, and it is possible to effectively prevent changes in the external appearance due to friction (for example, decreases in the glossiness, decreases in the aesthetics (the aesthetic external appearance and the like). It may be considered that these excellent effects are exhibited due to the dendritic polymer which contains a fluorine atom having a highly branched structure (hyperbranched structure) and being bulky and having a low specific gravity in comparison with a typical fluorine-containing material (for example, a fluorine-based resin such as PTFE or PVDF) and thus being excellent in the dispersion stability in the ultraviolet-curable composition. In addition, the dendritic polymer is generally a dendritic polymer in particle form having a high sphericity (sphericity) and has a high degree of symmetry, and, unlike a normal polymer material, the molecular weight distribution is extremely sharp, and the particle size distribution is also extremely sharp. As a result, it is considered that it is possible to effectively suppress thixotropy of the ultraviolet-curable composition. In addition, controlling the generation (number of branches of the dendron portion) during synthesis makes it possible to easily and reliably obtain particles with a desired size. From these excellent characteristics, it is possible to stably exhibit the excellent effect described above. In addition, adjusting the position, the presence ratio, and the like of the fluorine atom of the synthetic raw material of the dendritic polymer which contains a fluorine atom (in particular, the constituent component of the dendron portion) makes it possible to favorably adjust the surface free energy of the dendritic polymer (fluorine-containing powder) or the affinity with the polymerizable compound. As a result, it is possible to satisfy both of excellent abrasion resistance and film strength of the printed portion at a high level.

In contrast, in a case where the ultraviolet-curable composition does not contain a dendritic polymer (fluorine-containing powder) which contains a fluorine atom, it is possible to make the abrasion resistance of the printed portion formed using the ultraviolet-curable composition sufficiently excellent. In addition, the storage stability of the ultraviolet-curable composition is also decreased.

In addition, the excellent effects described above are not obtained even in a case where a powder (for example, a powder obtained by a method such as a grinding method, or the like) formed of a single fluorine-based material is included instead of the dendritic polymer which contains a fluorine atom. More specifically, in a case where a powder formed of a single fluorine-based material is included instead of the dendritic polymer which contains a fluorine atom, the specific weight of the powder which is formed of the fluorine-based material is high, aggregation or precipitation of the powder formed of the fluorine-based material occurs easily in long-term storage, it is difficult to make the storage stability of the ultraviolet-curable composition sufficiently excellent, and it is difficult to make the glossiness and the abrasion resistance of the printed portion formed using the ultraviolet-curable composition sufficiently excellent.

The ultraviolet-curable composition of the invention may be applied onto a recording medium by any method; however, the ultraviolet-curable composition is preferably applied (discharged) with the ink jet method. In the ink jet method, suitable application is possible to the forming of fine patterns or the recording on curved surfaces. In addition, although it is necessary for the ink (the ultraviolet-curable composition) to pass through a fine flow path such as a nozzle in the ink jet method, in a case where the storage stability of the ink (the ultraviolet-curable composition) deteriorates, there are problems in that aggregation or precipitation of the solid content is generated in this portion, the discharge stability is decreased due to an increase in the viscosity due to gelling, and it is not possible to form a desired pattern (printed portion); however, in the invention, it is possible to reliably prevent the generation of these problems even in a case of applying the ultraviolet-curable composition in the ink jet method. That is, the effects of the invention are more remarkably exhibited in a case of applying the ultraviolet-curable composition with the ink jet method. In the description below, description will be given focusing on a case where the ultraviolet-curable composition of the invention is applied with the ink jet method.

### Metal Powder

Regarding the constituent particles of the metal powder, it is sufficient if a site (for example, the vicinity of a surface) which is seen externally is at least formed of a metal material and, for example, the entirety may be formed of a metal material, or there may be a base portion which is formed of a non-metal material and a coated film which is formed of a metal material which covers the base portion. In addition, a surface treatment layer may be provided by a surface treatment agent with respect to base particles where a region which includes at least the vicinity of the surface is formed of the metal material.

In addition, it is possible to use a single metal, various types of alloys, or the like as the metal material which forms the constituent particles of the metal powder; however, the metal material is preferably mainly formed of Al.

Due to this, it is possible to make the glossiness and sense of luxury of the recorded matter particularly excellent while suppressing increases in the production cost of the recorded matter. In addition, Al naturally has particularly excellent glossiness among various types of metal materials; however, the present inventors discovered that the storage stability of the ultraviolet-curable composition is particularly low and the problem of decreases in the discharge stability due to increases in the viscosity due to gelling occurs particularly easily in a case of trying to apply particles which are formed of Al to the ultraviolet-curable composition. In contrast, in the invention, it is possible to reliably prevent the occurrence of the problem described above even in a case of using particles which are formed of Al. That is, in a case where the metal material which forms the metal powder is mainly formed of Al, the effects of the invention are more remarkably exhibited.

The metal powder may be produced by any method; however, it is preferably obtained by forming a film which is formed of a metal material by a vapor phase film-forming method and then grinding the film. Due to this, it is possible to effectively express the natural glossiness or the like of the metal material in a pattern (a printed portion) which is formed using the ultraviolet-curable composition of the invention. In addition, it is possible to suppress variations in the characteristics between each of the particles. In addition, it is possible to favorably produce even a comparatively thin metal powder using this method.

In a case of producing a metal powder using this method, for example, it is possible to favorably produce the metal powder by forming (film-forming) a film which is formed of a metal material on a substrate. It is possible to use, for example, a plastic film such as polyethylene terephthalate or the like as the substrate. In addition, the substrate may have a releasing agent layer on the film-forming surface.

In addition, the grinding is preferably performed by applying ultrasonic vibration to the film in a liquid. Due to this, it is possible to easily and reliably obtain a metal powder with the particle diameter which will be described below and to suppress the generation of variations in the size, shape, and characteristics between each of the particles.

In addition, as the liquid in a case of grinding with the above method, it is possible to suitably use alcohols such as methanol, ethanol, propanol, and butanol, hydrocarbon-based compounds such as n-heptane, n-octane, decane, dodecane, tetradecane, toluene, xylene, cymene, durene, indene, dipentene, tetrahydronaphthalene, decahydronaphthalene, and cyclohexylbenzene, ether-based compounds such as ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, diethylene glycol mono-butyl ether acetate, diethylene glycol n-butyl ether, tripropylene glycol dimethyl ether, triethylene glycol diethyl ether, 1,2-dimethoxyethane, bis(2-methoxyethyl) ether, and p-dioxane, and polar compounds such as propylene carbonate, γ-butyrolactone, N-methyl-2-pyrrolidone, N,N-dimethylformamide (DMF), N,N-dimethylacetamide (DMA), dimethyl sulfoxide, cyclohexanone, and acetonitrile. By using the liquid, it is possible to make the productivity of the metal powder particularly excellent while preventing unwanted oxidization or the like of the metal powder and also to make the variations in the size, shape, and characteristics between each of the particles particularly small.

Description will be given below of a case where the constituent particles of the metal powder are particles where base particles (base particles where a region which includes at least the vicinity of the surface is formed of a metal material) are subjected to a surface treatment by a surface treatment agent.

The surface treatment agent has a function of increasing the dispersion stability of the metal powder (particles) in the ultraviolet-curable composition and increasing the discharge stability with the ink jet method. In addition, as long as surface treatment is carried out such that surface energy of the metal powder is decreased, even in a case of using a polymerizable compound with a low surface tension as the constituent material of the ultraviolet-curable composition, it is possible to reliably more favorably array (carry out leafing) the metal powder in the vicinity of the outer surface of the printed portion in the recorded matter produced using the ultraviolet-curable composition and to more effectively exhibit characteristics such as the natural glossiness of the metal material which forms the metal powder. Therefore, the range of the options for the polymerizable compound widens and it is possible to easily adjust the characteristics of the ultraviolet-curable composition or the characteristics of the recorded matter produced using the ultraviolet-curable composition (for example, the viscosity, the storage stability, and the discharge stability of the ultraviolet-curable composition, the abrasion resistance of the recorded matter, or the like) without sacrificing the natural glossiness of the metal material.

As the surface treatment agent, it is possible to use, for example, a short chain compound which has an alkyl group which may have a substituent group with 2 to 4 carbon atoms, a long chain compound which has an alkyl group which may have a substituent group with 8 to 20 carbon atoms, a silane compound, a phosphate compound, a carboxylic acid compound, an isocyanate compound, and the like.

In a case where the alkyl group of the short chain compound and/or the alkyl group of the long chain compound has a substituent group, examples of the substituent group include a halogen group such as a fluoro group, a chloro group, a bromo group, a hydroxyl group, and the like.

As a silane compound, it is possible to use a compound which has a structure in which hydrogen atoms and/or hydrocarbon groups (including ones in which some or all of the hydrogen atoms are substituted with other atoms or an atomic group) are directly bonded to silicon atoms.

In more detail, as the silane compound, it is possible to use, for example, silicon hydride (SiₙH₂ₙ₊₂ (here, n is an integer of 1 or more)), HₐSiR₍₄₋ₐ₎ (here, R is a hydrocarbon group which may have a substituent group and a is an integer of 1 to 4), and the like.

As a phosphate compound, it is possible to use, for example, a compound (a long chain alkyl-based phosphate compound) which has at least one alkyl group with 6 or more carbon atoms in the molecule.

In particular, the phosphate compound (a long chain alkyl-based phosphate compound) preferably has a chemical structure which is represented by Formula (1) described below.

PORₙ(OH)₃₋ₙ (1)

(in formula (1), R is CH₃(CH₂)ₘ—, CH₃ (CH₂)ₘ (CH₂O)₁—, CH₃(CH₂)ₘ(CH₂CH₂O)₁—, or CH₃(CH₂)ₘO—, n is an integer of 1 to 3, m is an integer of 5 to 19, and 1 is an integer of 2 to 20).

Due to this, it is possible to make the storage stability of the ultraviolet-curable composition and the discharge stability with an ink jet method particularly excellent and to make the glossiness and abrasion resistance of the printed portion of the recorded matter produced using the ultraviolet-curable composition particularly excellent.

In Formula (1), m is preferably an integer of 5 to 19 and more preferably an integer of 7 to 17. Due to this, the effects as described above are more remarkably exhibited.

In addition, in Formula (1), 1 is preferably an integer of 2 to 20 and more preferably an integer of 4 to 16. Due to this, the effects as described above are more remarkably exhibited.

As a carboxylic acid, it is possible to use a compound (fatty acid) which has a hydrocarbon group and a carboxyl group. Specific examples of the compound include decanoic acid, tetradecanoic acid, octadecanoic acid, cis-9-octadecenoic acid, and the like.

As an isocyanate compound, it is possible to use a compound which has a partial structure which is represented by —N═C═O. The compound modifies a surface of the particles (the base particles) as a compound which has a partial structure which is represented by —NHCOO— by reacting with the metal material which forms the metal powder (base particles); however, the force of a hydrogen bond acts in the partial structure which is represented by —NHCOO—. For this reason, it is possible to carry out fine surface treatment on the surface of the particles and to remarkably exhibit the effects as described above.

As an isocyanate compound, it is possible to use a compound which has at least one isocyanate group in the molecule.

As the isocyanate compound, it is possible to use, for example, a compound which has a chemical structure which is represented by Formula (2) described below.

RNCO (2)

(in Formula (2), R is CH₃(CH₂)ₘ— and m is an integer of 2 to 18).

In Formula (2), m is preferably an integer of 3 to 14 and more preferably an integer of 4 to 12.

For example, a fluorine-based compound (a fluorine-based surface treatment agent) may be used as a surface treatment agent.

Due to this, it is possible to make the dispersion stability and chemical stability of the metal powder in the ultraviolet-curable composition particularly excellent and to make the storage stability of the ultraviolet-curable composition and the discharge stability over long periods particularly excellent. In addition, in the recorded matter produced using the ultraviolet-curable composition, it is possible to favorably arrange the metal powder (metal powder which is subjected to a surface treatment by a fluorine-based surface treatment agent) in the vicinity of the outer surface of the printed portion along with the dendritic polymer which contains a fluorine atom, it is possible to sufficiently exhibit characteristics such as the natural glossiness of the metal material which forms the metal powder to make the abrasion resistance of a printed portion particularly excellent, and to more effectively prevent changes in appearance due to friction (for example, a decrease in the glossiness, a decrease in aesthetics (aesthetic appearance) and the like). In particular, by the surface treatment agent of the metal powder and the dendritic polymer which contains a fluorine atom being formed of a fluorine-base material in common, it is possible to arrange the dendritic polymer which contains a fluorine atom in the vicinity of the constituent particles of the metal powder in the printed portion, thus it is possible to make the abrasion resistance of the printed portion a higher level and more reliably excellent, and to remarkably exhibit the above effects. In addition, by the particles which form the metal powder being subjected to a surface treatment by a fluorine-based surface treatment agent, even in a case of using a polymerizable compound with a low surface tension or a polymerizable compound with high viscosity and low fluidity as a constituent material of the ultraviolet-curable composition, it is possible to more favorably array (carry out leafing) the metal powder within a desired time in the vicinity of the outer surface of the printed portion in the recorded matter produced using the ultraviolet-curable composition and to more effectively exhibit characteristics such as the natural glossiness of the metal material which forms the metal powder. Accordingly, the range of the options for the polymerizable compound widens and it is possible to easily adjust the characteristics of the ultraviolet-curable composition or the characteristics of the recorded matter produced using the ultraviolet-curable composition (for example, the viscosity, the storage stability, and the discharge stability of the ultraviolet-curable composition, the abrasion resistance of the recorded matter, or the like) without sacrificing the natural glossiness of the metal material.

The fluorine-based compound (the fluorine-based surface treatment agent) preferably has a perfluoro alkyl structure.

Due to this, it is possible to make the storage stability of the ultraviolet-curable composition superior and to make the glossiness and abrasion resistance of the printed portion of the recorded matter produced using the ultraviolet-curable composition superior.

In addition, it is sufficient if the fluorine-based compound (the fluorine-based surface treatment agent) includes at least one fluorine atom in the molecule, and more specific examples thereof include a compound (a fluorine-based short chain compound, a fluorine-based long chain compound, a fluorine-based silane compound, a fluorine-based phosphate compound, a fluorine-substituted fatty acid, a fluorine-based isocyanate compound, and the like) which has a structure in which at least some of the hydrogen atoms of the short chain compound, the long chain compound, the silane compound, the phosphate compound, the carboxylic acid, and the isocyanate compound described above are substituted with fluorine atoms and the like.

The effects as described above are more remarkably exhibited by using the compound as the surface treatment agent. In particular, it is possible to more effectively decrease the surface free energy of the constituent particles of the metal powder, the difference of the interface energy with a polymerizable compound is made larger and the hydrophobic interaction acts more strongly, and to more effectively array the metal powder on the surface of the recorded matter. As a result, it is possible to make the glossiness of the recorded matter particularly excellent.

Among these, in a case of using the fluorine-based silane compound, the recorded matter produced using the ultraviolet-curable composition exhibits particularly excellent durability and weather resistance and it is possible to maintain the hardness of the film over a longer period.

In addition, since the phosphate compound surface treatment agent is strong against acid, in a case of using a fluorine-based phosphate compound, the recorded matter produced using the ultraviolet-curable composition exhibits excellent durability and weather resistance even under an acidic environment.

In addition, in a case of using a fluorine-substituted fatty acid (a fluorine-based fatty acid), it is possible to more effectively perform the surface treatment with respect to the base particles which are formed of noble metals such as gold, silver, and platinum, copper, aluminum, and the like and, since it is possible to form a film (a surface treatment layer) of which a functional group is small and the crystallinity is high, it is possible to effectively decrease the surface free energy. As a result, it is possible to effectively line up smaller particles on the surface of the recorded matter and to further improve the abrasion resistance.

In addition, in a case of using a fluorine-based isocyanate compound, it is possible to carry out a finer surface treatment with respect to the base particles and to strengthen the bonding force with the base particles and, since the durability of the metal powder is increased, it is possible to maintain the abrasion resistance over a longer period.

The fluorine-based silane compound preferably has the chemical structure which is represented by Formula (3) described below.

R¹SiX¹ₐR²₍₃₋ₐ₎ (3)

(in Formula (3), R¹ represents a hydrocarbon group in which some or all of the hydrogen atoms are substituted with fluorine atoms, X¹ represents a hydrolyzable group, an ether group, a chloro group, or a hydroxyl group, R² represents an alkyl group with 1 to 4 carbon atoms, and a is an integer of 1 to 3).

Due to this, it is possible to make the storage stability of the ultraviolet-curable composition and the discharge stability with the ink jet method particularly excellent and to make the glossiness and abrasion resistance of the printed portion of the recorded matter produced using the ultraviolet-curable composition particularly excellent.

Examples of R¹ in formula (3) include an alkyl group, an alkenyl group, an aryl group, an aralkyl group and the like in which some or all of the hydrogen atoms of these group are substituted with a fluorine atom, furthermore, at least a part of the hydrogen atoms included in the molecular structure (hydrogen atoms which are not substituted with fluorine atoms) may be substituted with an amino group, a carboxyl group, a hydroxyl group, a thiol group or the like, or an aromatic ring such as a heteroatom such as —O—, —S—, —NH—, or —N═ or benzene may be included in the carbon chain. Specific examples of R¹ include a phenyl group, a benzyl group, a phenethyl group, a hydroxyphenyl group, a chlorophenyl group, an amino phenyl group, a naphthyl group, an anthranilic group, a pyrenyl group, a thienyl group, a pyrrolyl group, a cyclohexyl group, a cyclohexenyl group, a cyclopentyl group, a cyclopentenyl group, a pyridinyl group, a methyl group, an ethyl group, a n-propyl group, an isopropyl group, a n-butyl group, an isobutyl group, a sec-butyl group, a tert-butyl group, an octadecyl group, a n-octyl group, a chloromethyl group, a methoxyethyl group, a hydroxyethyl group, an amino ethyl group, a cyano group, a mercaptopropyl group, a vinyl group, an allyl group, an acryloxyethyl group, a methacryloxy ethyl group, a glycidoxypropyl group, an acetoxy group, and the like in which some or all of the hydrogen atoms of these groups are substituted with fluorine atoms.

Examples of the fluorine-based silane compound which has a perfluoro alkyl structure (CₙF₂ₙ₊₁) include the compound represented by Formula (4) below.

CₙF₂ₙ₊₁(CH₂)ₘSiX¹ₐR²₍₃₋ₐ₎ (4)

(in Formula (4), X¹ represents a hydrolyzable group, an ether group, a chloro group, or a hydroxyl group, R² represents an alkyl group with 1 to 4 carbon atoms, n is an integer of 1 to 14, m is an integer of 2 to 6, and a is an integer of 1 to 3).

Specific examples of the compound which has the structure include CF₃—CH₂CH₂—Si(OCH₃)₃, CF₃(CF₂)₃—CH₂CH₂—Si(OCH₃)₃, CF₃(CF₂)₅—CH₂CH₂—Si(OCH₃)₃, CF₃(CF₂)₅—CH₂CH₂—Si(OC₂H₅)₃, CF₃(CF₂)₇—CH₂CH₂—Si(OCH₃)₃, CF₃(CF₂)₁₁—CH₂CH₂—Si(OC₂H₅)₃, CF₃(CF₂)₃—CH₂CH₂—Si(CH₃)(OCH₃)₂, CF₃(CF₂)₇—CH₂CH₂—Si(CH₃)(OCH₃)₂, CF₃(CF₂)₈—CH₂CH₂—Si(CH₃)(OC₂H₅)₂, CF₃(CF₂)₈—CH₂CH₂—Si(C₂H₅) (OC₂H₅)₂, and the like.

In addition, as the fluorine-based silane compound, it is also possible to use a compound which has a perfluoro alkyl ether structure (CₙF₂ₙ₊₁O) instead of the perfluoro alkyl structure (CₙF₂ₙ₊₁) described above.

Examples of the fluorine-based silane compound which has a perfluoro alkyl ether structure (CₙF₂ₙ₊₁O) include the compound represented by Formula (5).

CₚF₂ₚ₊₁O(CₚF₂ₚO)ᵣ(CH₂)ₘSiX¹ₐR²₍₃₋ₐ₎ (5)

(in Formula (5), X¹ represents a hydrolyzable group, an ether group, a chloro group, or a hydroxyl group, R² represents an alkyl group with 1 to 4 carbon atoms, p is an integer of 1 to 4, r is an integer of 1 to 10, m is an integer of 2 to 6, and a is an integer of 1 to 3).

Specific examples of the compound having such a structure include CF₃O(CF₂O)₆—CH₂CH₂—Si(OC₂H₅)₃, CF₃O(C₃F₆O)₄—CH₂CH₂—Si(OCH₃)₃, CF₃O(C₃F₆O)₂(CF₂O)₃—CH₂CH₂—Si(OCH₃)₃, CF₃O(C₃F₆O)₈—CH₂CH₂—Si(OCH₃)₃, CF₃O(C₄F₉O)₅—CH₂CH₂—Si(OCH₃)₃, CF₃O(C₄F₉O)₅—CH₂CH₂—Si(CH₃)(OC₂H₅)₂, CF₃O(C₃F₆O)₄—CH₂CH₂—Si(C₂H₅) (OCH₃)₂, and the like.

As the fluorine-based phosphate compound, it is possible to use a phosphate compound which has at least one fluorine atom in the molecule.

In particular, the fluorine-based phosphate compound preferably has the chemical structure which is represented by Formula (6) described below.

PORₙ(OH)3₋ₙ (6)

(in formula (6), R is CF₃(CF₂)ₘ—, CF₃(CF₂)ₘ(CH₂)₁—, CF₃(CF₂)ₘ(CH₂O)₁—, CF₃(CF₂)ₘ (CH₂CH₂O)₁—, CF₃(CF₂)ₘO—, or, CF₃(CF₂)ₘ(CH₂)₁O—, n is an integer of 1 to 3, m is an integer of 2 to 18, and 1 is an integer of 1 to 18).

Due to this, it is possible to make the storage stability of the ultraviolet-curable composition and the discharge stability with the ink jet method particularly excellent and to make the glossiness and abrasion resistance of the printed portion of the recorded matter produced using the ultraviolet-curable composition particularly excellent.

In Formula (6), m is preferably an integer of 3 to 14 and more preferably an integer of 4 to 12. Due to this, the effects as described above are more remarkably exhibited.

In addition, in Formula (6), 1 is preferably an integer of 1 to 14 and more preferably an integer of 1 to 10. Due to this, the effects as described above are more remarkably exhibited.

As the fluorine-substituted fatty acid (the fluorine-based fatty acid), it is possible to use a fatty acid which has at least one fluorine atom in the molecule.

Examples of the fluorine-substituted fatty acid include CF₃—CH₂CH₂—COOH, CF₃(CF₂)₃—CH₂CH₂—COOH, CF₃(CF₂)₅—CH₂CH₂—COOH, CF₃(CF₂)₆—CH₂CH₂—COOH, CF₃(CF₂)₇—CH₂CH₂—COOH, CF₃(CF₂)₉—CH₂CH₂—COOH, and esters thereof and the like, among them, CF₃(CF₂)₅—CH₂CH₂—COOH is preferable.

Due to this, since it is possible to make a stronger bond with silicon or the metal atoms such as, aluminum, magnesium, and titanium which form the base particles by a dehydration reaction due to heating and to form a fine film, it is possible to effectively decrease the surface energy of the particles.

As the fluorine-based isocyanate compound, it is possible to use a compound which has at least one fluorine atom and at least one isocyanate group in the molecule.

As the fluorine-based isocyanate compound, it is possible to use a compound which has the chemical structure which is represented by Formula (7) described below.

RfNCO (7)

(in Formula (7), Rf is CF₃(CF₂)ₘ— or CF₃(CF₂)ₘ(CH₂)₁—, m is an integer of 2 to 18, and 1 is an integer of 1 to 18).

Due to this, it is possible to make the storage stability of the ultraviolet-curable composition and the discharge stability with the ink jet method particularly excellent. In addition, in the recorded matter produced using the ultraviolet-curable composition, it is possible to more favorably array (carry out leafing) the metal powder in the vicinity of the outer surface of the printed portion and to make the glossiness of the printed portion of the produced recorded matter particularly excellent. In addition, it is possible to make the abrasion resistance of the printed portion of the produced recorded matter particularly excellent.

In Formula (7), m is preferably an integer of 3 to 14 and more preferably an integer of 4 to 12. Due to this, the effects as described above are more remarkably exhibited.

In addition, in Formula (7), 1 is preferably an integer of 1 to 14 and more preferably an integer of 1 to 10. Due to this, the effects as described above are more remarkably exhibited.

In addition, the metal powder may be subjected to a surface treatment by a plurality of types of surface treatment agents. In this case, the surface treatment by a plurality of types of surface treatment agents may be carried out on the same particles or the metal powder may include a plurality of types of particles subjected to a surface treatment by different surface treatment agents.

The surface treatment agent described above may directly treat the base particles; however, the treatment by the surface treatment agent is preferably performed with respect to the base particles after the base particles are processed with an acid or a base. Due to this, it is possible to more reliably carry out modification by chemical bonding with the base particle surface using the surface treatment agent and to more effectively exhibit the effects as described above. As an acid, it is possible to use, for example, proton acids such as hydrochloric acid, sulfuric acid, phosphoric acid, nitric acid, acetic acid, carbonic acid, formic acid, benzoic acid, chlorous acid, hypochlorous acid, sulfurous acid, hyposulfurous acid, nitrous acid, hyponitrous acid, phosphorous acid, and hypophosphorous acid. Among these, hydrochloric acid, phosphoric acid, and acetic acid are favorable. On the other hand, as a base, it is possible to use, for example, sodium hydroxide, potassium hydroxide, calcium hydroxide, and the like. Among these, sodium hydroxide and potassium hydroxide are favorable.

In a case of carrying out a plurality of types of surface treatments on the same particles, the surface treatments may be performed by being divided into a plurality of steps which correspond to each of the surface treatment agents or the surface treatments may be performed in the same step by a plurality of types of surface treatment agents.

In addition, for example, the surface treatment of the base particles using the surface treatment agent may be performed by including the surface treatment agent in a liquid when grinding the film made of a metal which is formed by a vapor phase film-forming method in the liquid and forming the base particles as described above.

Due to this, it is possible to perform the surface treatment along with the forming of the base particles, and to make the productivity of the metal powder and the ultraviolet-curable composition particularly excellent. In addition, it is possible to carry out the surface treatment on each site of the metal powder with high uniformity. In addition, in a case of using the agents described above as the surface treatment agent (particularly in a case of using a fluorine-based phosphate compound), by the surface treatment agent acting so as to promote the dispersion of the metal powder and the energy of the grinding being efficiently transmitted to the individual particles by ultrasonic waves or the like, it is possible to more efficiently grind the film in a shorter time, to more efficiently obtain a metal powder with little size variation which satisfies the particle diameter conditions which will be described below, and to make the productivity of the metal powder and the ultraviolet-curable composition superior.

In a case of carrying out a plurality of types of surface treatments on the same particles, the surface treatments may be performed by being divided into a plurality of steps which correspond to each of the surface treatment agents or the surface treatments may be performed in the same step by a plurality of types of surface treatment agents.

The particles which form the metal powder may take any shape such as a sphere, a spindle, or a needle, but are preferably flaky.

Due to this, it is possible to arrange the metal powder such that the main surfaces of the particles are along the surface shape of the recording medium on the recording medium to which the ultraviolet-curable composition is added, it is possible to effectively exhibit the natural glossiness or the like of the metal material which forms the metal powder even in the obtained recorded matter and to make the glossiness and sense of luxury of the formed pattern (a printed portion) particularly excellent. In addition, in a case where the metal powder is subjected to the surface treatment described above, it is possible to make the abrasion resistance of the recorded matter particularly excellent.

In the invention, flaky refers to a shape of which an area when observed from a predetermined angle (when viewed in plan) is larger than an area when observed from an angle which is orthogonal with the observing direction as a flat shape, a curved plane, or the like, and, in particular, the ratio (S₁/S₀) with respect to an area S₁ [μm²] when observed (when viewed in plan view) from a direction in which the projection area is the maximum and an area S₀ [μm²] when observed from a direction in which an area when observed in the direction which orthogonal to the observing direction is the maximum is preferably 2 or more, more preferably 5 or more, and even more preferably 8 or more. As the value, it is possible to, for example, adopt the average value of the calculated values for 10 arbitrary particles by observing the particles.

In a case where the particles which form the metal powder are flaky, the average thickness of the particles is preferably 10 nm to 80 nm, and more preferably 20 nm to 70 nm.

For example, the ratio (S₁/S₀) and the thickness can be observed using a transmission electron microscope and a scanning electron microscope, and specific examples include a transmission electron microscope (TEM, JOEL JEM-2000EX), a field emission scanning electron microscope (FE-SEM, Hitachi S-4700), a scanning transmission electron microscope (STEM, “HD-2000” manufactured by Hitachi High-Technologies Corporation) and the like. The thickness means an average thickness and is an average value obtained such that the measurement is performed 10 times.

Due to this, the effects due to the particles described above being flaky are more remarkably exhibited.

The average thickness of the constituent particles of the metal powder is preferably larger than the average particle diameter of the dendritic polymer which contains a fluorine atom.

Due to this, in the recorded matter, the dendritic polymer which contains a fluorine atom can be more effectively prevented from being excessively present on the outer surface side (the side viewed by an observer) in comparison with the constituent particles of the metal powder, and it is possible to make the glossiness of the printed portion superior.

The average particle diameter (D₅₀) of the metal powder is preferably 200 nm to 3.0 μm, more preferably 250 nm to 640 nm, and even more preferably 300 nm to 600 nm.

Due to this, it is possible to make the glossiness and sense of luxury of the recorded matter produced using the ultraviolet-curable composition superior. In particular, in the printed portion of the recorded matter, it is possible to more effectively prevent the dendritic polymer which contains a fluorine atom being excessively exposed on the outer surface and the texture (the glossiness and the like) forming the metal powder from being inhibited, and to make the glossiness and sense of luxury of the recorded matter superior. In addition, it is possible to make the storage stability and discharge stability of the ultraviolet-curable composition superior.

In contrast, when the average particle diameter of the metal powder is less than the lower limit, the aggregation of the metal powder occurs easily in the ultraviolet-curable composition, and the storage stability of the ultraviolet-curable composition may be decreased. In addition, due to the aggregation occurring, involuntary color irregularities tend to occur in the printed portion formed using the ultraviolet-curable composition.

In addition, when the average particle diameter of the metal powder exceeds the upper limit, the discharge stability of the ultraviolet-curable composition with the ink jet method may be decreased.

Here, in the invention, the average particle diameter refers to the median diameter of volume distribution where the particle dispersing liquid is measured using a laser diffraction scattering method and, in a case where a large number of measurement results are represented as the accumulation of the presence ratios for each size (particle diameter), the average particle diameter is the size (the volume average particle diameter) of the particles which exhibits exactly 50% of the central value in the accumulation. Examples of the measurement device include a laser diffraction scattering particle size analyzer, Microtrack MT-3000 (manufactured by Nikkiso Co., Ltd.). The volume average particle diameters (D50) in the below-described Examples are values measured by the above-described Microtrack MT-3000.

The particle diameter (D₁₀) at a volume accumulation distribution ratio 10% from the fine particle side of the metal powder is preferably 80 nm to 1.1 μm, more preferably 100 nm to 1.1 μm, and even more preferably 150 nm to 400 nm.

Due to this, it is possible to make the particle distribution of the metal powder sharper and to make the discharge stability of the ultraviolet-curable composition with an ink jet method particularly excellent.

The particle diameter (D₉₀) at a volume accumulation distribution ratio 90% from the fine particle side of the metal powder is preferably 300 nm to 4.0 μm, more preferably 400 nm to 1.1 μm, and even more preferably 500 nm to 1.0 μm.

Due to this, it is possible to make the particle distribution of the metal powder sharper and to make the discharge stability of the ultraviolet-curable composition with an ink jet method particularly excellent.

The half-value width in the particle distribution of the metal powder (the distance between D25 and D75) is preferably 0.50 μm or less, more preferably 0.45 μm or less, and even more preferably 0.30 μm or less.

Due to this, it is possible to make the particle distribution of the metal powder sharper and to make the discharge stability of the ultraviolet-curable composition with an ink jet method particularly excellent.

In addition, in the ultraviolet-curable composition of the invention, the metal powder preferably includes constituent particles subjected to a surface treatment; however, particles not subjected to a surface treatment may be included as some of the constituent particles of the metal powder. However, even in such a case, the content ratio of the constituent particles subjected to a surface treatment with respect to all of the metal powder is preferably 90 mass % or more, more preferably 95 mass % or more, and even more preferably 99 mass % or more.

Due to this, the above effects are more remarkably exhibited.

The content ratio of the metal powder in the ultraviolet-curable composition is preferably 0.9 mass % to 29 mass % and more preferably 1.2 mass % to 19.3 mass %.

Due to this, it is possible to satisfy both the glossiness and the abrasion resistance of the printed portion which is formed using the ultraviolet-curable composition at a higher level. In addition, it is possible to make the storage stability of the ultraviolet-curable composition and the discharge stability of the ultraviolet-curable composition with an ink jet method particularly excellent.

### Dendritic Polymer Containing Fluorine Atom

As described above, the ultraviolet-curable composition of the invention includes a dendritic polymer which contains a fluorine atom.

The dendritic polymer which contains a fluorine atom preferably has transparency in a cured product state where a polymerizable compound which forms the ultraviolet-curable composition is cured. Due to this, it is possible to make the aesthetic appearance of the recorded matter produced using the ultraviolet-curable composition of the invention particularly excellent.

Here, the transmittance (the transmittance of light with a wavelength of 600 nm) of visible light in a thickness direction of the cured product with a thickness of 100 which is formed by curing the ultraviolet-curable composition which has the same composition as the above apart from not including the metal powder is preferably 85% or more and more preferably 90% or more.

Due to this, since the light for curing the polymerizable compound easily passes through the dendritic polymer (dendritic polymer which contains a fluorine atom), the curing of the ultraviolet-curable composition proceeds uniformly up to the inner portion when forming the recorded matter, and it is possible to make the aesthetic external appearance of the recorded matter produced using the ultraviolet-curable composition of the invention superior.

In the invention, the dendritic polymer is a concept which includes dendrimers or hyperbranched polymers and, in a case of a dendrimer, a core and dendrons are generally provided. On the other hand, the hyperbranched polymer has a single skeleton structure without the distinction of a core or dendron.

As the dendritic polymer which contains a fluorine atom (in particular, a dendrimer), it is possible to use, for example, polymers having an acrylic skeleton, polymers having an epoxy skeleton, polymers having a polyamidoamine (PAMAM) skeleton, polymers having a bis(hydroxy methyl) propanoic acid (MPA) skeleton, polymers having a polypropylene imine skeleton, polymers having a polylysine skeleton, polymers having a polyphenyl ether skeleton, polymers having a dithiocarbamate skeleton, and the like; however, in particular, polymers having an acrylic skeleton or a dithiocarbamate skeleton are preferable.

Due to this, the transparency of the dendritic polymer in the printed portion is particularly excellent and it is possible to make the aesthetics (the aesthetic external appearance) of the recorded matter particularly excellent. In addition, since a dendritic polymer (the dendritic polymer which contains a fluorine atom) having an acrylic skeleton is excellent in the affinity with the polymerizable compound to be described in detail below, it is possible to make the storage stability and the like of the ultraviolet-curable composition particularly excellent, it is possible to make the adhesion between the polymer of the polymerizable compound in the printed portion formed using the ultraviolet-curable composition and the dendritic polymer which contains a fluorine atom particularly excellent, and to make the abrasion resistance, the film strength, and the like of the printed portion particularly excellent.

Examples of the core in a case where the dendritic polymer (dendritic polymer which contains a fluorine atom) included in the ultraviolet-curable composition of the invention is a dendrimer include multi-functional acrylates such as penta erythritol hexaacrylate, trimethylolpropane triacrylate, and pentaerythritol tetraacrylate.

Examples of the dendrons of the dendritic polymer (dendritic polymer which contains a fluorine atom) included in the ultraviolet-curable composition of the invention include tri-functional or higher multi-functional acrylates and the like.

In addition, as dendritic polymer which contains a fluorine atom and the fluorine atom-containing low molecule (constituent part of the dendron) which forms the dendritic polymer, it is possible to use those disclosed in JP-A-2002-220468, JP-A-2003-226611, JP-A-2009-235372, and the like.

In addition, it is possible to use, for example, a dendritic polymer which has a dithiocarbamate skeleton and which is disclosed in Japanese Patent Application No. 2012-546933 (P2012-546933) as a dendritic polymer in a case where the dendritic polymer (a dendritic polymer which contains a fluorine atom) which is included in the ultraviolet-curable composition is a hyperbranched polymer.

The surface free energy of the dendritic polymer which contains a fluorine atom is preferably 18 mN/m to 28 mN/m, and more preferably 19 mN/m to 25 mN/m.

Due to this, it is possible to make the abrasion resistance of the printed portion particularly excellent while making the discharge stability of the ultraviolet-curable composition with an ink jet method particularly excellent.

The average particle diameter (D₅₀) of the dendritic polymer which contains a fluorine atom is preferably 2 nm to 20 nm, more preferably 2 nm to 10 nm, and even more preferably 2.5 nm to 9 nm.

Due to this, it is possible to make the glossiness and abrasion resistance of the printed portion formed using the ultraviolet-curable composition particularly excellent while the storage stability of the ultraviolet-curable composition is particularly excellent.

In contrast, when the average particle diameter of the dendritic polymer which contains a fluorine atom is less than the lower limit, the abrasion resistance of the printed portion formed using the ultraviolet-curable composition is decreased. In addition, the storage stability of the ultraviolet-curable composition and the discharge stability with the ink jet method are also decreased.

In addition, when the average particle diameter of the dendritic polymer which contains a fluorine atom exceeds the upper limit, the glossiness of the printed portion is decreased, and the aesthetics (the aesthetic external appearance) of the recorded matter is decreased. In addition, the storage stability of the ultraviolet-curable composition and the discharge stability with the ink jet method are also decreased.

When the thickness of the metal powder is T_{M} [μm] and the average particle diameter of the dendritic polymer which contains a fluorine atom is D_{F} [IM], a relationship of 0.05≦D_{F}/T_{M}≦0.7 is preferably satisfied, a relationship of 0.07≦D_{F}/T_{M}≦0.5 is more preferably satisfied, and a relationship of 0.10≦D_{F}/T_{M}≦0.35 is even more preferably satisfied.

Due to this, in the recorded matter, the dendritic polymer which contains a fluorine atom is more effectively prevented from being excessively present on the outer surface side (the side viewed by an observer) in comparison with the constituent particles of the metal powder, it is possible to make the glossiness of the printed portion superior, and it is possible to make the abrasion resistance of the recorded matter particularly excellent.

When the average particle diameter of the metal powder is D_{M} [μm] and the average particle diameter of the dendritic polymer which contains a fluorine atom is D_{F} [μm], a relationship of 5≦D_{M}/D_{F}≦300 is preferably satisfied, a relationship of 15≦D_{M}/D_{F}≦200 is more preferably satisfied, and a relationship of 25≦D_{M}/D_{F}≦200 is even more preferably satisfied.

Due to this, it is possible to make the glossiness of the printed portion superior and to make the abrasion resistance of the recorded matter particularly excellent.

The particle diameter (D₁₀) at a volume accumulation distribution ratio 10% from the fine particle side of the dendritic polymer which contains a fluorine atom is preferably 0.7 nm to 45 nm, more preferably 1.7 nm to 9 nm, and even more preferably 2.2 nm to 8 nm.

Due to this, it is possible to make the particle distribution of the dendritic polymer which contains a fluorine atom sharper and to make the storage stability of the ultraviolet-curable composition and the discharge stability of the ultraviolet-curable composition with the ink jet method particularly excellent.

The particle diameter (D₉₀) at a volume accumulation distribution ratio 90% from the fine particle side of the dendritic polymer which contains a fluorine atom is preferably 1.3 nm to 55 nm, more preferably 2.3 nm to 11 nm, and even more preferably 2.7 nm to 10 nm.

Due to this, it is possible to make the particle distribution of the dendritic polymer which contains a fluorine atom sharper and to make the storage stability of the ultraviolet-curable composition and the discharge stability of the ultraviolet-curable composition with the ink jet method particularly excellent.

The half-width in the particle size distribution of the dendritic polymer which contains a fluorine atom (the distance between D25 and D75) is preferably 2 nm or less, more preferably 1 nm or less, and even more preferably 0.5 nm or less.

Due to this, it is possible to make the particle distribution of the dendritic polymer which contains a fluorine atom sharper and to make the discharge stability of the ultraviolet-curable composition with an ink jet method particularly excellent.

The dendritic polymer which contains a fluorine atom is normally spherical.

Due to this, it is possible to make the abrasion resistance of the recorded matter produced using the ultraviolet-curable composition more reliably excellent. In addition, in a case where the dendritic polymer which contains a fluorine atom is spherical, it is possible to make the content ratio of the dendritic polymer which contains a fluorine atom in the ultraviolet-curable composition (in the printed portion) high and to more effectively prevent the dendritic polymer which contains a fluorine atom from adversely influencing the external appearance of the recorded matter while more effectively exhibiting the effects of including the dendritic polymer which contains a fluorine atom as described above.

The content ratio of the dendritic polymer which contains a fluorine atom in the ultraviolet-curable composition is preferably 0.010 mass % to 5.0 mass %, more preferably 0.050 mass % to 4.0 mass %, and even more preferably 0.10 mass % to 3.0 mass %.

Due to this, it is possible to satisfy both of the glossiness and the abrasion resistance of the printed portion formed using the ultraviolet-curable composition at a higher level.

When the content ratio of the metal powder in the ultraviolet-curable composition is X_{M} [mass %] and the content ratio of the dendritic polymer which contains a fluorine atom is X_{F} [mass %], a relationship of 0.05≦X_{F}/X_{M}≦0.5 is preferably satisfied, and a relationship of 0.07≦X_{F}/X_{M}≦0.45 is more preferably satisfied.

Due to this, it is possible to satisfy both the glossiness and the abrasion resistance at a higher level in the recorded matter produced using the ultraviolet-curable composition.

### Polymerizable Compound

The polymerizable compound is a component which is polymerized by being irradiated with ultraviolet rays to be cured. Including the component makes it possible to make the abrasion resistance, water resistance, solvent resistance, and the like of the recorded matter produced using the ultraviolet-curable composition excellent.

The polymerizable compound is in liquid form and preferably functions as a dispersing medium which disperses the metal powder and the dendritic polymer which contains a fluorine atom in the ultraviolet-curable composition.

Due to this, since it is not necessary to separately use a dispersing medium which is removed (evaporated) in the process of producing the recorded matter and it is not necessary to provide a step of removing the dispersing medium even when producing the recorded matter, it is possible to make the productivity of the recorded matter particularly excellent. In addition, since it is not necessary to use a dispersing medium which is generally used as an organic solvent, it is possible to prevent occurrence of the problem of volatile organic compounds (VOC). In addition, by including a polymerizable compound, it is possible to make the adhesiveness of the printed portion which is formed using the ultraviolet-curable composition excellent with respect to various types of recording media (substrates). That is, by including a polymerizable compound, the ultraviolet-curable composition is excellent in terms of corresponding to the media.

It is sufficient if the polymerizable compound is a component which is polymerized by being irradiated with ultraviolet rays, and it is possible to use, for example, various types of monomers, various types of oligomers (which include dimers, trimers, and the like), and the like; however, the ultraviolet-curable composition preferably includes at least a monomer component as a polymerizable compound. Since a monomer is generally a component with low viscosity compared to an oligomer component or the like, it is advantageous in terms of making the discharge stability of the ultraviolet-curable composition particularly excellent.

In particular, the ultraviolet-curable composition preferably includes a monomer which has an alicyclic structure as a polymerizable compound.

By including a monomer which has an alicyclic structure along with the metal powder (in particular, metal powder subjected to the surface treatment with the surface treating agent described above) and the dendritic polymer which contains a fluorine atom, it is possible to make the storage stability and discharge stability of the ultraviolet-curable composition particularly excellent and it is also possible to make the glossiness and abrasion resistance of the recorded matter produced using the ultraviolet-curable composition particularly excellent.

It is considered these excellent effects are obtained for the following reasons. That is, by including the monomer having an alicyclic structure, it is possible to make the dispersion stability of the dendritic polymer which contains a fluorine atom and the metal powder in the ultraviolet-curable composition particularly excellent, and to favorably prevent aggregation, precipitation, and the like of the dendritic polymer which contains a fluorine atom and the metal powder in the ultraviolet-curable composition over long periods. Thus, it is considered that, by these effects mutually acting synergistically with the effect from including the dendritic polymer which contains a fluorine atom, it is possible to make the storage stability of the ultraviolet-curable composition particularly excellent, and to make the glossiness and the abrasion resistance of the recorded matter produced using the ultraviolet-curable composition particularly excellent.

Examples of the monomer having an alicyclic structure include tris(2-(meth)acryloyloxyethyl) isocyanurate, dicyclopentenyloxyethyl (meth)acrylate, adamantyl (meth)acrylate, γ-butyrolactone (meth)acrylate, N-vinyl caprolactam, N-vinylpyrrolidone, pentamethylpiperidyl (meth)acrylate, tetramethyl piperidyl (meth)acrylate, 2-methyl-2-adamantyl (meth)acrylate, 2-ethyl-2-adamantyl (meth)acrylate, mevalonic lactone (meth)acrylate, dimethylol tricyclodecane di(meth)acrylate, dimethylol dicyclopentane di(meth)acrylate, dicyclopentenyl (meth)acrylate, dicyclopentanyl (meth)acrylate, isobornyl (meth)acrylate, cyclohexyl (meth)acrylate, (meth)acryloyl morpholine, tetrahydrofurfuryl (meth)acrylate, phenyl glycidyl ether (meth)acrylate, EO-modified hydrogenated bisphenol A di(meth)acrylate, di(meth)acrylated isocyanurate, tri(meth)acrylated isocyanurate and the like, and preferably include one type or two or more types selected from a group formed of tris(2-acryloyloxyethyl) isocyanurate, dicyclopentenyloxyethyl acrylate, adamantyl acrylate, γ-butyrolactone acrylate, N-vinyl caprolactam, N-vinylpyrrolidone, pentamethylpiperidyl acrylate, tetramethyl piperidyl acrylate, 2-methyl-2-adamantyl acrylate, 2-ethyl-2-adamantyl acrylate, mevalonic lactone acrylate, dimethylol tricyclodecane diacrylate, dimethylol dicyclopentane diacrylate, dicyclopentenyl acrylate, dicyclopentanyl acrylate, isobornyl acrylate, cyclohexyl acrylate, acryloylmorpholine, tetrahydrofurfuryl acrylate, cyclohexane spiro-2-(1,3-dioxolan-4-yl) methyl acrylate, (2-methyl-2-ethyl-1,3-dioxolan-4-yl) methyl acrylate, and cyclic trimethylolpropane formal acrylate.

Due to this, it is possible to make the glossiness and sense of luxury of the recorded matter produced using the ultraviolet-curable composition superior. In addition, it is possible to make the storage stability and discharge stability of the ultraviolet-curable composition superior.

Among these, in a case of including one type or two or more types selected from a group formed of acryloyl morpholine, tetrahydrofurfuryl acrylate, γ-butyrolactone acrylate, N-vinyl caprolactam, and N-vinyl pyrrolidone, it is possible to further make the dispersion stability of the metal powder and the dendritic polymer which contains a fluorine atom in the ultraviolet-curable composition and the discharge stability with the ink jet method superior and it is also possible to favorably array the metal powder in the vicinity of the outer surface of the printed portion in the recorded matter produced using the ultraviolet-curable composition and to make the glossiness of the obtained recorded matter superior.

In addition, from the point of view of the curing speed of the ultraviolet-curable composition when irradiated with ultraviolet rays and further improvement of the productivity of the recorded matter, it is preferable to include one type or two or more types selected from a group formed of tris(2-acryloyloxyethyl) isocyanurate, dicyclopentenyloxyethyl acrylate, γ-butyrolactone acrylate, N-vinylpyrrolidone, dimethylol tricyclodecane diacrylate, dimethylol dicyclopentane diacrylate, dicyclopentenyl acrylate, dicyclopentanyl acrylate, acryloylmorpholine, cyclic trimethylolpropane formal acrylate, and tetrahydrofurfuryl acrylate, and more preferably, acryloylmorpholine, and/or γ-butyrolactone acrylate, and even more preferably γ-butyrolactone acrylate.

In addition, in a case of including one type or two or more types selected from a group formed of cyclohexyl acrylate, tetrahydrofurfuryl acrylate, and benzyl acrylate, it is possible to make the flexibility of the printed portion which is formed by curing the ultraviolet-curable composition superior.

In addition, from the point of view of further improving the abrasion resistance of the printed portion which is formed by curing the ultraviolet-curable composition, it is preferable to include one type or two or more types selected from a group formed of tris(2-acryloyloxyethyl) isocyanurate, dicyclopentenyloxyethyl acrylate, adamantyl acrylate, γ-butyrolactone acrylate, N-vinyl caprolactam, N-vinylpyrrolidone, dimethylol tricyclodecane diacrylate, dimethylol dicyclopentane diacrylate, dicyclopentenyl acrylate, dicyclopentanyl acrylate, isobornyl acrylate, and acryloyl morpholine, and more preferably γ-butyrolactone acrylate, and/or N-vinylcaprolactam.

In addition, in a case of including one type or two or more types selected from a group formed of γ-butyrolactone acrylate, N-vinyl caprolactam, N-vinyl pyrrolidone, isobornyl acrylate, and tetrahydrofurfuryl acrylate, it is possible to more effectively prevent decreases in the glossiness or the like due to unwanted creases or the like being generated in the printed portion, which is formed by curing the ultraviolet-curable composition, by reducing the contraction rate when curing the ultraviolet-curable composition.

The content ratio of the monomer which has an alicyclic structure in the ultraviolet-curable composition is preferably 40 mass % to 90 mass %, more preferably 50 mass % to 88 mass %, and even more preferably 55 mass % to 85 mass %.

Due to this, the dispersion stability of the metal powder and the dendritic polymer which contains a fluorine atom and the storage stability of the ultraviolet-curable composition are particularly excellent, and excellent discharge stability is obtained over a long period. In particular, the excellent effects described above are obtained even when the ultraviolet-curable composition does not include a dispersing agent. Here, the ultraviolet-curable composition may include two or more types of compounds as a monomer which has an alicyclic structure. In this case, the total content ratio thereof is preferably a value within these ranges.

Regarding the monomer which has an alicyclic structure, the number of constituent atoms in the cyclic structure which is formed by a common bond is preferably 5 or more and more preferably 6 or more.

Due to this, it is possible to make the storage stability of the ultraviolet-curable composition particularly excellent.

As a monomer which has an alicyclic structure, the ultraviolet-curable composition preferably includes a monofunctional monomer (a monofunctional monomer which has a hetero ring which does not exhibit aromaticity) which includes a hetero atom in an alicyclic structure.

As a result, the dispersion stability of the metal powder and the dendritic polymer which contains a fluorine atom is particularly excellent and it is possible to obtain particularly excellent discharge stability over a long period of time. In particular, the excellent effects described above are obtained even when the ultraviolet-curable composition does not include a dispersing agent. Examples of such monofunctional monomers include tris(2-(meth)acryloyloxyethyl) isocyanurate, γ-butyrolactone (meth)acrylate, N-vinyl caprolactam, N-vinylpyrrolidone, pentamethylpiperidyl (meth)acrylate, tetramethyl piperidyl (meth)acrylate, mevalonic lactone (meth)acrylate, (meth)acryloyl morpholine, tetrahydrofurfuryl (meth)acrylate, and the like.

The content ratio of the monofunctional monomer (a monofunctional monomer which includes a hetero atom in an alicyclic structure) in the ultraviolet-curable composition is preferably 10 mass % to 80 mass % and more preferably 15 mass % to 75 mass %.

Due to this, it is possible to favorably use the above for producing recorded matter which is provided with a pattern (a printed portion) in which curing contraction is suppressed, there is little scattering, and the glossiness is superior. Here, the ultraviolet-curable composition may include two or more types of compounds as the single functional monomer which includes a hetero atom in an alicyclic structure. In this case, the total of the content ratio is preferably a value within these ranges.

In the invention, the polymerizable compound which forms the ultraviolet-curable composition may include a monomer which does not have an alicyclic structure.

Examples of such monomers (monomers which do not have an alicyclic structure) include phenoxyethyl (meth)acrylate, benzyl (meth)acrylate, ethoxylated orthophenylphenol (meth)acrylate, 2-(2-vinyloxyethoxy) ethyl (meth)acrylate, dipropylene glycol di(meth)acrylate, tripropylene glycol di(meth)acrylate, 2-hydroxy 3-phenoxypropyl (meth)acrylate, and 4-hydroxybutyl (meth)acrylate lauryl (meth)acrylate, 2-methoxyethyl (meth)acrylate, isooctyl (meth)acrylate, stearyl (meth)acrylate, 2-ethoxyethyl (meth)acrylate, 1H, 1H, 5H-octafluoropentyl (meth)acrylate, 2-hydroxyethyl (meth)acrylate, 2-hydroxypropyl (meth)acrylate, isobutyl (meth)acrylate, t-butyl (meth)acrylate, ethyl carbitol (meth)acrylate, 2,2,2-trifluoroethyl (meth)acrylate, 2,2,3,3-tetra-fluoro-propyl (meth)acrylate, methoxy triethylene glycol (meth)acrylate, PO-modified nonylphenol (meth)acrylate, EO-modified nonylphenol (meth)acrylate, EO-modified 2-ethylhexyl (meth)acrylate, phenoxy diethylene glycol (meth)acrylate, EO-modified phenol (meth)acrylate, EO-modified cresol (meth)acrylate, methoxy polyethylene glycol (meth)acrylate, dipropylene glycol (meth)acrylate, 2-N-butyl-2-ethyl-1,3-propanediol di(meth)acrylate, tetraethylene glycol di(meth)acrylate, 1,9-nonanediol di(meth)acrylate, 1,4-butanediol di(meth)acrylate, bisphenol A EO-modified di(meth)acrylate, 1,6-hexanediol di(meth)acrylate, polyethylene glycol 200 di(meth)acrylate, polyethylene glycol 300 di(meth)acrylate, neopentyl glycol hydroxypivalate di(meth)acrylate, 2-ethyl-2-butyl-propane diol di(meth)acrylate, polyethylene glycol 400 di(meth)acrylate, polyethylene glycol 600 di(meth)acrylate, polypropylene glycol di(meth)acrylate, PO-modified bisphenol A di(meth)acrylate, trimethylolpropane tri(meth)acrylate, pentaerythritol tri(meth)acrylate, trimethylolpropane EO-modified tri(meth)acrylate, glycerin PO-added tri(meth)acrylate, tris(meth)acryloyloxyethyl phosphate, pentaerythritol tetra(meth)acrylate, PO-modified trimethylolpropane tri(meth)acrylate, 2-(meth)acryloyloxyethyl phthalate, 3-(meth)acryloyloxy propyl acrylate, w-carboxy (meth)acryloyloxyethyl phthalate, ditrimethylolpropane tetra(meth)acrylate, dipentaerythritol penta/hexa (meth)acrylate, dipentaerythritol hexa (meth)acrylate, and the like, and preferably include one type or two or more types selected from a group formed of phenoxyethyl acrylate, benzyl acrylate, 2-(2-vinyloxyethoxy) ethyl acrylate, dipropylene glycol diacrylate, tripropylene glycol diacrylate, 2-hydroxy 3-phenoxypropyl acrylate, and 4-hydroxybutyl acrylate.

Including the monomer which does not have an alicyclic structure in addition to the monomer which has an alicyclic structure makes the reactivity of the ultraviolet-curable composition after discharging with an ink jet method excellent, while making the storage stability and discharge stability of the ultraviolet-curable composition excellent, and it is possible to make the productivity of the recorded matter particularly excellent and also to make the abrasion resistance or the like of the formed pattern particularly excellent.

Among these, in a case of including phenoxyethyl acrylate, it is possible to favorably array the metal powder in the vicinity of the outer surface of the printed portion in the recorded matter produced using the ultraviolet-curable composition and to make the glossiness of the obtained recorded matter superior. In addition, in the recorded matter produced using the ultraviolet-curable composition, it is possible to more favorably arrange the dendritic polymer which contains a fluorine atom in the vicinity of the outer surface of the printed portion, and to make the abrasion resistance of the obtained recorded matter superior.

In addition, in a case of including acrylic acid 2-(2-vinyloxyethoxy) ethyl, it is possible to make the curing speed of the ultraviolet-curable composition when irradiated with ultraviolet rays and the productivity of the recorded matter superior.

In addition, in a case of including phenoxyethyl acrylate and/or 2-hydroxy 3-phenoxypropyl acrylate, it is possible to make the flexibility of the printed portion which is formed by curing the ultraviolet-curable composition superior.

In addition, from the point of view of further improving the abrasion resistance of the printed portion which is formed by curing the ultraviolet-curable composition, one type or two or more types selected from a group formed of acrylic acid 2-(2-vinyloxyethoxy) ethyl, dipropylene glycol diacrylate, and tripropylene glycol diacrylate are preferably included, and acrylic acid 2-(2-vinyloxyethoxy) ethyl is more preferably included.

In addition, in a case of including phenoxyethyl acrylate, it is possible to more effectively prevent a decrease in the glossiness or the like due to unwanted creases or the like being generated in the printed portion which is formed by curing the ultraviolet-curable composition by making the contraction rate when curing the ultraviolet-curable composition smaller.

The content ratio of monomers other than a monomer which has an alicyclic structure in the ultraviolet-curable composition is preferably 5 mass % to 50 mass %, and more preferably 10 mass % to 40 mass %.

Due to this, the adjustment of the curing speed, flexibility, the contraction rate when curing, or the like of the ultraviolet-curable composition is easier. Here, the ultraviolet-curable composition may include two or more types of compounds as the monomer which does not have an alicyclic structure. In this case, the total content ratio is preferably a value within these ranges.

The ultraviolet-curable composition may include an oligomer (which includes a dimer, trimer, and the like), a prepolymer, and the like other than a monomer as a polymerizable compound. It is possible to use an oligomer and a prepolymer, for example, which have the monomer as described above as a constituent component. The ultraviolet-curable composition particularly preferably includes a multi-functional oligomer.

Due to this, it is possible to make the abrasion resistance or the like of a formed pattern excellent while making the storage stability of the ultraviolet-curable composition and the discharge stability with an ink jet method excellent. As an oligomer, a urethane oligomer of which the repeating structure is urethane, an epoxy oligomer of which the repeating structure is epoxy, and the like are preferably used.

The content ratio of the polymerizable compound in the ultraviolet-curable composition is preferably 70 mass % to 99 mass %, and more preferably 80 mass % to 98 mass %.

Due to this, it is possible to make the storage stability, discharge stability, and curability of the ultraviolet-curable composition superior, and it is also possible to make the glossiness, abrasion resistance, and the like of the recorded matter produced using the ultraviolet-curable composition superior. Here, the ultraviolet-curable composition may include two or more types of compounds as a polymerizable compound. In this case, the total content ratio of the compounds is preferably a value within these ranges.

### Substance A

In addition, the ultraviolet-curable composition of the invention preferably includes a substance A which has a partial structure which is shown by Formula (8).

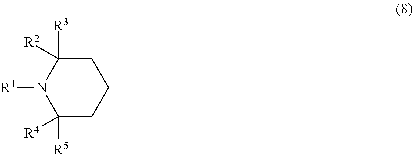

(In Formula (8), R¹ indicates an oxygen atom, a hydrogen atom, a hydrocarbon group, or an alkoxyl group and R², R³, R⁴, and R⁵ each independently indicate a hydrogen atom or a hydrocarbon group.)

By the ultraviolet-curable composition including the substance A which has the chemical structure along with the dendritic polymer which contains a fluorine atom and moreover including a monomer which has an alicyclic structure, it is possible to make the storage stability, and curability of the ultraviolet-curable composition particularly excellent. In addition, in the recorded matter produced using the ultraviolet-curable composition, it is possible to more effectively exhibit the natural glossiness and sense of luxury of the metal material which forms the metal powder, make the glossiness and abrasion resistance of the printed portion particularly excellent, and make the durability of the recorded matter particularly excellent.

In Formula (8), it is sufficient if R² is an oxygen atom, a hydrogen atom, a hydrocarbon group, or an alkoxyl group (a group in which a chain or alicyclic hydrocarbon group is bonded with an oxygen atom); however, a hydrogen atom, a methyl group, or an octyloxy group is particularly preferable. Due to this, it is possible to make the storage stability and discharge stability of the ultraviolet-curable composition superior and to make the glossiness and abrasion resistance of the printed portion which is formed using the ultraviolet-curable composition superior.

In addition, in Formula (8), it is sufficient if R² to R⁵ are each independently a hydrogen atom or a hydrocarbon group; however, an alkyl group with 1 to 3 carbon atoms is preferable, and a methyl group is more preferable. Due to this, it is possible to make the storage stability and discharge stability of the ultraviolet-curable composition superior and to make the glossiness and abrasion resistance of the printed portion which is formed using the ultraviolet-curable composition superior.

The content ratio of the substance A in the ultraviolet-curable composition is preferably 0.1 mass % to 5.0 mass % and more preferably 0.5 mass % to 3.0 mass %.

Due to this, it is possible to make the storage stability, discharge stability, and curability of the ultraviolet-curable composition superior and it is also possible to make the glossiness, abrasion resistance, and the like of the recorded matter produced using the ultraviolet-curable composition superior. Here, the ultraviolet-curable composition may include two or more types of compounds as the substance A. In this case, the total of the content ratio of the compounds is preferably a value within these ranges.

When the content ratio of the substance A is X_{A} [mass %] and the content ratio of the metal powder is X_{M} [mass %], a relationship of 0.01≦X_{A}/X_{M}≦0.8 is preferably satisfied and a relationship of 0.05≦X_{A}/X_{M}≦0.4 is more preferably satisfied.

By satisfying the relationship, it is possible to make the storage stability and discharge stability of the ultraviolet-curable composition superior and to make the glossiness and abrasion resistance of the printed portion which is formed using the ultraviolet-curable composition superior.

### Defoaming Agent

The ultraviolet-curable composition may include a defoaming agent as an additive.

Since it is possible to reduce the surface tension of the ultraviolet-curable composition and greatly reduce air bubbles which are generated at the meniscus position in the vicinity of the nozzles, it is possible to make the discharge stability in the ink jet of the ultraviolet-curable composition excellent.

In contrast, in a case where the ultraviolet-curable composition does not contain a defoaming agent, by the pigment or fluorine-containing particles subjected to a treatment by a fluorine-based surface treatment agent with low surface free energy being easily arrayed on a gas-liquid interface in the air bubbles which are generated in the ultraviolet-curable composition, it is possible for the air bubbles to be stably present for a long time. As a result, discharge energy which is generated from piezoelectric elements or the like in an ink jet method being absorbed or attenuated in the stabilized air bubbles causes various problems such as discharge failures, decreases in the liquid droplet weight, decrease in the flying speed of liquid droplets, or bending in the flying direction. For this reason, it is not possible to sufficiently make the discharge stability excellent and the uniformity of the ultraviolet-curable composition also remarkably deteriorates.

In particular, it is possible to make the discharge stability excellent by using an acryl-based defoaming agent which includes fluorine or an acryl-based defoaming agent which does not have a polar functional group as a defoaming agent. Since the molecular weight of the defoaming agents is small and the dispersing and moving speed is extremely fast compared to the pigment or fluorine-containing particles subjected to a treatment by a fluorine-based surface treatment agent, it is possible to effectively suppress the generation of air bubbles.

Specific examples of the acryl-based defoaming agent which includes fluorine which is able to be used in the invention include BYK-3440 (produced by BYK Japan KK), BYK-3441 (produced by BYK Japan KK), and the like.

In addition, the acryl-based defoaming agent which does not have a polar functional group which is able to be used in the invention is an acrylic copolymer which does not have a functional group such as a hydroxyl group, an amino group, a carboxyl group, a cyano group, and a ketone group of which the electronegativity is high in the molecule as a polar functional group, and specific examples thereof include DISPERBYK-354 (produced by BYK Japan KK), DISPERBYK-392 (produced by BYK Japan KK), and the like.

The content of the defoaming agent is preferably 1.5 weight % and more preferably 0.1 weight % to 1.0 weight %.

Due to this, it is possible to make the storage stability, discharge stability, and curability of the ultraviolet-curable composition superior, while making the glossiness of the recorded matter produced using the ultraviolet-curable composition sufficiently excellent. Here, the defoaming agent may include two or more types of compounds as the acryl-based defoaming agent which includes fluorine or the acryl-based defoaming agent which does not have a polar functional group.

In this case, the total of the content ratio of the compounds is preferably a value within these ranges. Here, when the content ratio of the defoaming agent in the ultraviolet-curable composition is extremely high, it is difficult to favorably arrange the metal powder and fluorine-containing powder in the vicinity of the outer surface of the ultraviolet-curable composition due to the concentration of the excess defoaming agent which does not affect defoaming being increased and there is a possibility that it will be difficult to make the glossiness and abrasion resistance of the recorded matter (printed portion) which is finally obtained sufficiently excellent.

### Dispersing Agent

The ultraviolet-curable composition of the invention may include a dispersing agent.

Due to this, it is possible to make the dispersion stability of the metal powder and the fluorine-containing powder in the ultraviolet-curable composition superior and to make the storage stability of the ultraviolet-curable composition superior.

In particular, the ultraviolet-curable composition of the invention may include a dispersing agent having a polymer structure which has an acidic group (referred to below as an “acidic group-containing polymer dispersing agent”).

Due to this, it is possible to make the discharge stability of the ultraviolet-curable composition superior.

Here, as long as the acidic group-containing polymer dispersing agent has a polymer structure which has an acidic group such as carboxylic acid, phosphoric acid, or a sulfonic acid group, the specific molecular weight is not limited.

The polymer structure which forms the acidic group-containing polymer dispersing agent is not particularly limited; however, examples thereof include an acrylic-based polymer structure (including copolymers), a methacrylic-based polymer structure (including copolymers), a polyurethane-based polymer structure, a hydroxyl group-containing carboxylic acid ester structure, a polyether-based polymer structure, a silicone-based polymer structure, and the like.

The acid value of the acidic group-containing polymer dispersing agent is not particularly limited and is preferably 3 mgKOH/g to 200 mgKOH/g, and more preferably 10 mgKOH/g to 120 mgKOH/g.

Specific examples of the polymer dispersing agent having an acidic group which can be used in the invention include DISPERBYK-102 (produced by BYK Japan KK), DISPERBYK-106 (produced by BYK Japan KK), DISPERBYK-110 (produced by BYK Japan KK), DISPERBYK-111 (produced by BYK Japan KK), DISPERBYK-140 (produced by BYK Japan KK), DISPERBYK-142 (produced by BYK Japan KK), DISPERBYK-145 (produced by BYK Japan KK), DISPERBYK-118 (produced by BYK Japan KK), DISPERBYK-180 (produced by BYK Japan KK), DISPERBYK-191 (produced by BYK Japan KK), DISPERBYK-2095 (produced by BYK Japan KK), DISPERBYK-2096 (produced by BYK Japan KK), Plysurf A212C (produced by DKS Co., Ltd.), Plysurf A215C (produced by DKS Co., Ltd.), Plysurf A208N (produced by DKS Co., Ltd.), Plysurf A219B (produced by DKS Co., Ltd.), PN-411 (produced by Ajinomoto Fine-Techno Co., Inc.), PA-111 (produced by Ajinomoto Fine-Techno Co., Inc.), and the like.

In a case where the ultraviolet-curable composition includes a dispersing agent, the content ratio of the dispersing agent in the ultraviolet-curable composition is preferably 5.0 mass % or less, and more preferably 0.01 mass % to 2.0 mass %.

Due to this, it is possible to make the storage stability, discharge stability, and curability of the ultraviolet-curable composition superior, while making the glossiness of the recorded matter produced using the ultraviolet-curable composition sufficiently excellent. Here, the ultraviolet-curable composition may include two or more types of compounds as the acidic polymer dispersing agent (acidic group-containing polymer dispersing agent). In this case, the sum of the content ratio of these compounds is preferably a value within these ranges. Here, when the content ratio of the dispersing agent in the ultraviolet-curable composition is excessively high, by increasing the concentration of the excess dispersing agent which does not act on the dispersion due to a so-called depletion effect of the polymer-dispersed liquid, particle aggregation is promoted by osmotic pressure generated in a case where the particles of the metal powder and the fluorine-containing powder are close, the average particle size is increased, and separation and precipitation from the ultraviolet curing component of the pigment are caused. As a result, in the ultraviolet-curable composition applied to the recording medium, the uniformity of the metal powder and the fluorine-containing powder is decreased and the fluidity of the powder particles is greatly decreased, it is difficult to favorably arrange the metal powder and the fluorine-containing powder in the vicinity of the outer surface of the applied ultraviolet-curable composition and there is a possibility that is will be difficult to make the glossiness and abrasion resistance of the finally obtained recorded matter (printed portion) sufficiently excellent.

### Other Components

The ultraviolet-curable composition of the invention may include components (other components) other than the components described above. Examples of the components include photopolymerization initiators, slipping agents (a levelling agent), solvents, polymerization promotors, polymerization inhibitors, permeation promotors, moistening agents (a moisturizer), coloring agents, fixing agents, antifungal agents, preservative agents, antioxidants, chelating agents, viscosity thickening agents, radio sensitizing agents (radio sensitizing pigments), and the like.

The photopolymerization initiator is not particularly limited as long as the photopolymerization initiator generates an active species such as radicals or cations by being irradiated with ultraviolet rays and initiates the polymerization reaction of the polymerizable compound described above. As the photopolymerization initiator, it is possible to use a photo-radical polymerization initiator or a photo-cation polymerization initiator; however, a photo-radical polymerization initiator is preferably used. In a case of using a photopolymerization initiator, the photopolymerization initiator preferably has an absorption peak in an ultraviolet ray region.

Examples of the photo-radical polymerization initiator include aromatic ketones, acyl phosphine oxide compounds, aromatic onium salt compounds, organic peroxide, thio compound (thioxanthone compounds, thiophenyl group-containing compounds, and the like), hexaarylbiimidazole compounds, ketoxime ester compounds, borate compounds, azinium compounds, metallocene compounds, active ester compounds, compounds which have a carbon halogen bond, alkylamine compounds, and the like.

Among these, from the point of view of the solubility in a polymerizable compound and curability, at least one type selected from an acyl phosphine oxide compound and a thioxanthone compound is preferable, and the use of an acyl phosphine oxide compound and a thioxanthone compound together is more preferable.

Specific examples of the photo-radical polymerization initiator include acetophenone, acetophenone benzyl ketal, 1-hydroxy cyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chloro benzophenone, 4,4′-dimethoxy benzophenone, 4,4′-diaminobenzophenone, Michler's ketone, benzoin propyl ether, benzoin ethyl ether, benzyl dimethyl ketal, 1-(4-isopropyl phenyl)-2-hydroxy-2-methyl propan-1-one, 2-hydroxy-2-methyl-1-phenyl propan-1-one, thioxanthone, diethylthioxanthone, 2-isopropylthioxanthone, 2-chlorothioxanthone, 2-methyl-1-[4-(methylthio) phenyl]-2-morpholino-propan-1-one, bis(2,4,6-trimethyl benzoyl)-phenyl phosphine oxide, 2,4,6-trimethyl benzoyl-diphenyl-phosphine oxide, 2,4-diethylthioxanthone, bis-(2,6-dimethoxybenzoyl)-2,4,4-trimethyl pentyl phosphine oxide and the like, and one type or two or more types selected from among these can be used in combination.

The content of the photopolymerization initiator in the ultraviolet-curable composition is preferably 0.5 mass % to 10 mass %.

When the content of the photopolymerization initiator is in this range, the ultraviolet ray curing speed is sufficiently high and there is little undissolved remaining photopolymerization initiator or coloring which is derived from the photopolymerization initiator.

When the ultraviolet-curable composition includes a slipping agent, the surface of the recorded matter is smooth due to the levelling effect and the abrasion resistance is improved.

It is possible to use a slipping agent without being particularly limited, and examples thereof include silicone-based surfactants such as polyester-modified silicone, polyether-modified silicone, and polyacrylate-modified silicone, and polymer-based surfactants such as polyacrylate, and polyester, and polyether-modified polydimethylsiloxane, polyester-modified polydimethylsiloxane, or polyacrylate-modified dimethylsiloxane are preferably used.

Here, the ultraviolet-curable composition of the invention may include a polymerization inhibitor; however, even in a case of including a polymerization inhibitor, the content of the polymerization inhibitor in the ultraviolet-curable composition is preferably 0.6 mass % or less and more preferably 0.3 mass % or less.

Due to this, since it is possible to make the content ratio of the polymerizable compound in the ultraviolet-curable composition relatively high, it is possible to make the abrasion resistance or the like of the printed portion which is formed using the ultraviolet-curable composition particularly excellent. In addition, in the invention, even in a case where the content ratio of the polymerization inhibitor is comparatively low, the storage stability and the discharge stability of the ultraviolet-curable composition can be made to be sufficiently excellent.

In addition, the ultraviolet-curable composition of the invention preferably does not include an organic solvent which is removed (evaporated) in a step of producing the recorded matter. Due to this, it is possible to effectively prevent the occurrence of the problem of volatile organic compounds (VOC).

The viscosity at room temperature (20° C.) of the ultraviolet-curable composition of the invention measured on the basis of JIS 28809 using a vibration-type viscometer, is preferably 25 mPa·s or less, and more preferably 3 mPa·s to 15 mPa·s.

Due to this, it is possible to suitably perform the liquid droplet discharge with the ink jet method.

### Recorded Matter

Next, description will be given of the recorded matter of the invention.

The recorded matter of the invention is produced by adding the ultraviolet-curable composition described above onto a recording medium and then irradiating the ultraviolet-curable composition with the ultraviolet rays. That is, the recorded matter of the invention is provided with a cured product of the ultraviolet-curable composition described above and a recording medium.

The recorded matter has a pattern (a printed portion) with excellent glossiness and abrasion resistance.

As described above, the ultraviolet-curable composition of the invention includes a polymerizable compound and is excellent in adhesion with respect to a recording medium. In this manner, since the ultraviolet-curable composition of the invention is excellent in adhesion to a recording medium, the recording medium may be any medium and either absorbent or non-absorbent media may be used, and it is possible to use, for example, paper (plain paper, ink jet specialty paper, and the like), plastic material, metal, ceramics, wooden material, shells, cotton, polyester, natural fiber and synthetic fiber such as wool, non-woven fabric, and the like. In addition, the shape of the recording medium is not particularly limited and may be any shape, such as a sheet.

As the liquid droplet discharging method (the ink jet method), it is possible to use a piezo method, a method of discharging ink by foam (bubbles) which are generated by heating the ink, or the like; however, from the point of view of difficulty in degeneration of the ultraviolet-curable composition or the like, a piezo method is preferable.

It is possible to discharge the ultraviolet-curable composition with an ink jet method using a liquid droplet discharging apparatus which is known in the art.

The ultraviolet-curable composition which is discharged with an ink jet method is cured by being irradiated with ultraviolet rays.

As an ultraviolet ray source, it is possible to use, for example, a mercury lamp, a metal halide lamp, an ultraviolet light emitting diode (UV-LED), an ultraviolet laser diode (UV-LD), and the like. Among these, an ultraviolet light emitting diode (UV-LED) and an ultraviolet laser diode (UV-LD) are preferable from the point of view of miniaturization, long life, high efficiency, and low costs.

The recorded matter of the invention may be for any use and, for example, may be applied to a decorative material or other use. Specific examples of the recorded matter of the invention include vehicular interior components such as a console lid, a switch base, a center cluster, an interior panel, an emblem, a center console, and a meter name plate, operation portions (key switches) of various types of electronic equipment, a decorative portion which exhibits a decorative property, an index, display objects such as logos, and the like.

Description was given above of the invention based on favorable embodiments; however, the invention is not limited thereto.

For example, in the embodiment described above, description was mainly given of the case where the recorded matter of the invention is formed by a recording medium (a substrate) and a printed portion; however, the recorded matter of the invention may have other configurations in addition to the recording medium (substrate) and the printed portion.

### EXAMPLE

Next, description will be given of specific examples of the invention.

### 1. Producing Composition for Producing Recorded Matter

### Example 1

Firstly, a film (with a surface roughness Ra of 0.02 μm or less) made of polyethylene terephthalate with a smooth surface is prepared.

Next, silicone oil is coated on the entirety of one surface of the film.

Next, a film which is formed of Al is formed on the surface side on which silicone oil is coated by a vapor deposition method.

Next, a film (a substrate) made of polyethylene terephthalate on which a film of Al was formed was inserted in a liquid which was formed by dissolving CF₃(CF₂)₅(CH₂)₂O(P)(OH)₂: 1 part by mass as a fluorine-based surface treatment agent in diethylene glycol diethyl ether: 99 parts by mass, and ultrasonic vibration of 27 kHz was applied at 55° C. for 3 hours. Due to this, a dispersing liquid of the metal powder formed of flaky particles where base particles made of Al were subjected to a surface treatment using CF₃(CF₂)₅(CH₂)₂O(P)(OH)₂ is obtained.

The volume average particle diameter (D₅₀) of the metal powder which was obtained in this manner is 0.45 μm, the particle diameter (D₁₀) at the volume accumulation distribution ratio 10% from the fine particle side of the metal powder was 0.28 μm, the particle diameter (D₉₀) at the volume accumulation distribution ratio 90% from the fine particle side of the metal powder was 0.77 μm, and the half-value width in the particle distribution of the metal powder was 0.32 μm.

Next, the composition for producing the recorded matter (the ultraviolet-curable composition) is obtained by mixing the dispersing liquid of the metal powder with a dendritic polymer which contains a fluorine atom (fluorine-containing powder), γ-butyrolactone acrylate as a monomer (a polymerizable compound) which has an alicyclic structure, phenoxyethyl acrylate as a monomer (a polymerizable compound) which does not have an alicyclic structure, the substance A which has a chemical structure which is represented by Formula (9) described below, DISPERBYK-118 (produced by BYK Japan KK) as the acidic group-containing polymer dispersing agent, Irgacure 819 (produced by BASF Corp.) as a photopolyerization initiator, Speedcure TPO (produced by ACETO Corp.) as a photopolyerization initiator, and Speedcure DETX (produced by Lambson Ltd.) as a photopolyerization initiator. Here, as the dendritic polymer which contains a fluorine atom, FA-200F (produced by Nissan Chemical Industries) was used, which is spherical particles of a hyperbranched polymer with a volume average particle diameter of 7.5 nm.

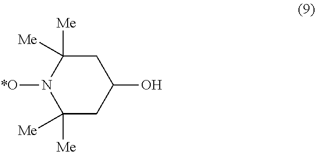

### Examples 2 to 20

The compositions for producing the recorded matter (the ultraviolet-curable composition) were produced in the same manner as Example 1 apart from forming the constituent particles of the metal powder and the dendritic polymer which contains a fluorine atom as shown in Table 1 and making the compositions as shown in Table 2 and Table 3 by changing the types and ratios of the raw materials used for preparation of the composition for producing the recorded matter (the ultraviolet-curable composition).

### Comparative Example 1

The composition for producing the recorded matter (the ultraviolet-curable composition) was produced in the same manner as Example 1 apart from not including a dendritic polymer which contains a fluorine atom.

### Comparative Example 2

The composition for producing the recorded matter (the ultraviolet-curable composition) was produced in the same manner as Example 1 apart from using a fluorine-containing powder (volume average particle diameter (D₅₀): 40 nm) formed of spherical particles formed of polytetrafluoroethylene instead of a dendritic polymer which contains a fluorine atom.

### Comparative Example 3

The composition for producing the recorded matter (the ultraviolet-curable composition) was produced in the same manner as Example 1 apart from using an Al powder (powder not subjected to a surface treatment using a surface treatment agent) with a spherical shape produced using a gas atomizer method as the metal powder.

Regarding each of Examples and Comparative Examples, the configurations of the metal powder and fluorine-containing powder included in the composition for producing the recorded matter (the ultraviolet-curable composition) are shown together in Table 1 and the compositions of the composition for producing the recorded matter (the ultraviolet-curable composition) are shown together in Table 2 and Table 3. Here, in the tables, CF₃(CF₂)₅(CH₂)₂O(P)(OH)₂ as a fluorine-based phosphate compound is shown as “FAP1”, (CF₃(CF₂)₇CH₂CH₂Si(OC₂H₅)₃) as a fluorine-based silane compound as “FAS1”, (CF₃(CF₂)₅CH₂CH₂Si(OC₂H₅)₃) as a fluorine-based silane compound as “FAS2”, CF₃(CF₂)₇(CH₂)₂COOH as a fluorine-substituted fatty acid as “FFA1”, CF₃(CF₂)₇(CH₂)₂NCO as a fluorine-based isocyanate compound as “IS1”, lauryl phosphoric acid: CH₃(CH₂)₁₁—(OCH₂CH₂)₂—O—PO(OH)₂ as an alkylphosphate compound as “LAP”, laures-2 phosphoric acid: CH₃(CH₂)₁₁—(OCH₂CH₂)₂—O—PO(OH)₂ as an alkyl ether phosphate compound as “LEP”, octyl triethoxy silane as an alkyl silane compound as “OTS”, CH₃(CH₂)₇O—PO(OH)₂ as “AP1”, a dendritic polymer formed of a dendrimer with an acrylic skeleton (dendritic polymer which contains a fluorine atom) as “FA-1”, a dendritic polymer formed of a dendrimer with an epoxy skeleton (dendritic polymer which contains a fluorine atom) as “FE-1”, FA-200F (produced by Nissan Chemical Industries, Ltd.) which is a dendritic polymer formed of a hyperbranched polymer (dendritic polymer which contains a fluorine atom) as “FA200”, FA-E-50 (produced by Nissan Chemical Industries, Ltd.) which is a dendritic polymer formed of a hyperbranched polymer (dendritic polymer which contains a fluorine atom) as “FA50”, FH1-50 (produced by Nissan Chemical Industries, Ltd.) which is a dendritic polymer formed of a hyperbranched polymer (dendritic polymer which contains a fluorine atom) as “FH1”, FX-032N (produced by Nissan Chemical Industries, Ltd.) which is a dendritic polymer formed of a hyperbranched polymer (dendritic polymer which contains a fluorine atom) as “FX”, polytetra fluoro ethylene as “PTFE”, γ-butyrolactone acrylate as a monomer (a polymerizable compound) which has an alicyclic structure as “BLA”, tetrahydrofurfuryl acrylate as a monomer (a polymerizable compound) which has an alicyclic structure as “THFA”, N-vinyl caprolactam as a monomer (a polymerizable compound) which has an alicyclic structure as “VC”, N-vinyl pyrrolidone as a monomer (a polymerizable compound) which has an alicyclic structure as “VP”, acryloyl morpholine as a monomer (a polymerizable compound) which has an alicyclic structure as “AMO”, tris(2-acryloyloxyethyl)isocyanurate as a monomer (a polymerizable compound) which has an alicyclic structure as “TAOEI”, dicyclopentenyloxyethyl acrylate as a monomer (a polymerizable compound) which has an alicyclic structure as “DCPTeOEA”, adamantyl acrylate as a monomer (a polymerizable compound) which has an alicyclic structure as “AA”, dimethylol tricyclodecane diacrylate as a monomer (a polymerizable compound) which has an alicyclic structure as “DMTCDDA”, dimethylol dicyclopentane diacrylate as a monomer (a polymerizable compound) which has an alicyclic structure as “DMDCPTA”, dicyclopentenyl acrylate as a monomer (a polymerizable compound) which has an alicyclic structure as “DCPTeA”, dicyclopentanyl acrylate as a monomer (a polymerizable compound) which has an alicyclic structure as “DCPTaA”, isobornyl acrylate as a monomer (a polymerizable compound) which has an alicyclic structure as “IBA”, cyclohexyl acrylate as a monomer (a polymerizable compound) which has an alicyclic structure as “CHA”, diacrylated isocyanurate as a monomer (a polymerizable compound) which has an alicyclic structure as “DAI”, triacrylated isocyanurate as a monomer (a polymerizable compound) which has an alicyclic structure as “TAI”, γ-butyrolactone methacrylate as a monomer (a polymerizable compound) which has an alicyclic structure as “BLM”, tetrahydrofurfuryl methacrylate as a monomer (a polymerizable compound) which has an alicyclic structure as “THFM”, dicyclopentenyloxyethyl methacrylate as a monomer (a polymerizable compound) which has an alicyclic structure as “DCPTeOEM”, adamantyl methacrylate as a monomer (a polymerizable compound) which has an alicyclic structure as “AM”, pentamethylpiperidyl methacrylate as a monomer (a polymerizable compound) which has an alicyclic structure as “PMPM”, tetramethylpiperidyl methacrylate as a monomer (a polymerizable compound) which has an alicyclic structure as “TMPM”, 2-methyl-2-adamantyl methacrylate as a monomer (a polymerizable compound) which has an alicyclic structure as “MAM”, 2-ethyl-2-adamantyl methacrylate as a monomer (a polymerizable compound) which has an alicyclic structure as “EAM”, mevalonic lactone methacrylate as a monomer (a polymerizable compound) which has an alicyclic structure as “MLM”, dicyclopentenyl methacrylate as a monomer (a polymerizable compound) which has an alicyclic structure as “DCPTeM”, dicyclopentanyl methacrylate as a monomer (a polymerizable compound) which has an alicyclic structure as “DCPTaM”, isobornyl methacrylate as a monomer (a polymerizable compound) which has an alicyclic structure as “IBM”, cyclohexyl methacrylate as a monomer (a polymerizable compound) which has an alicyclic structure as “CHM”, cyclohexanespiro-2-(1,3-dioxolane-4-il) methyl acrylate as a monomer (a polymerizable compound) which has an alicyclic structure as “CHDOLA”, (2-methyl-2-ethyl-1,3-dioxolane-4-il) methyl acrylate as a monomer (a polymerizable compound) which has an alicyclic structure as “MEDOLA”, phenoxyethyl acrylate as a monomer (a polymerizable compound) which does not have an alicyclic structure as “PEA”, dipropylene glycol diacrylate as a monomer (a polymerizable compound) which does not have an alicyclic structure as “DPGDA”, tripropylene glycol diacrylate as a monomer (a polymerizable compound) which does not have an alicyclic structure as “TPGDA”, 2-hydroxy-3-phenoxypropyl acrylate as a monomer (a polymerizable compound) which does not have an alicyclic structure as “HPPA”, 4-hydroxybutyl acrylate as a monomer (a polymerizable compound) which does not have an alicyclic structure as “HBA”, ethyl carbitol acrylate as a monomer (a polymerizable compound) which does not have an alicyclic structure as “ECA”, methoxy triethylene glycol acrylate as a monomer (a polymerizable compound) which does not have an alicyclic structure as “MTEGA”, t-butyl acrylate as a monomer (a polymerizable compound) which does not have an alicyclic structure as “TBA”, benzyl acrylate as a monomer (a polymerizable compound) which does not have an alicyclic structure as “BA”, acrylic acid 2-(2-hydroxyethoxy) ethyl as a monomer (a polymerizable compound) which does not have an alicyclic structure as “VEEA”, benzyl methacrylate as a monomer (a polymerizable compound) which does not have an alicyclic structure as “BM”, urethane acrylate as a monomer (a polymerizable compound) which does not have an alicyclic structure as “UA”, DISPERBYK-118 as an acidic polymer dispersing agent (produced by BYK Japan KK: 36 mgKOH/g) as “D1”, DISPERBYK-2090 as an acidic polymer dispersing agent (produced by BYK Japan KK: 61 mgKOH/g) as “D2”, Plysurf-A 219B as an acidic polymer dispersing agent (produced by DKS Co., Ltd: 50 mgKOH/g) as “D3”, the compound (the substance A) which is represented by Formula (9) described above as “A1”, the compound (the substance A) which is represented by Formula (10) described below as “A2”, the compound (the substance A) which is represented by Formula (11) described below as “A3”, the compound (the substance A) which is represented by Formula (12) described below as “A4”, BYK-3441 as a defoamer as “B3441”, DISPERBYK-354 as a defoamer as “D354”, DISPERBYK-392 as a defoamer as “D392”, Irgacure 819 (produced by BASF Corp.) as “ic819”, Speedcure TPO (produced by ACETO Corp.) as “scTPO”, Speedcure DETX (produced by Lambson Ltd.) as “scDETX”, BYK-350 (produced by BYK Japan KK) as “BY350”, hydroquinone monomethyl ether as “MEHQ”, LHP-96 (produced by Kusumono Chemicals Ltd.) as “LHP”, LF-1982 (produced by Kusumono Chemicals Ltd.) as “LF-1”, and LF-1984 (produced by Kusumono Chemicals Ltd.) as “LF-2”. In addition, in the tables, for Example 15, regarding the composition of the constituent material of the base particles, the content ratio of each element is shown by weight ratio. In addition, the viscosity at room temperature (20° C.) of the composition for producing the recorded matter (the ultraviolet-curable composition) of each Example measured on the basis of JIS 28809 using a vibration-type viscometer, was a value in a range of 3 mPa·s to 15 mPa·s. In addition, 10 arbitrary metal particles of each the metal powders forming the composition for producing the recorded matter (the ultraviolet-curable composition) in each of the Examples were observed, the ratio (S₁/S₀) was determined with respect to an area S₁ [μm²] when observed (when viewing in plan view) from the direction in which the projection area is the maximum and an area S₀ [μm²] when observed from a direction in which the area is the maximum when observing in the direction orthogonal to the observation direction, and the average value thereof was obtained, at which point the average values of S₁/S₀ were all or more. In addition, in Examples and Comparative Examples where a powder subjected to a surface treatment was used as the metal powder, the content ratio of the constituent particles subjected to a surface treatment with respect to all of the metal powder was 99 mass % or more in all cases. In addition, the visible light transmittance (wavelength: transmittance of light at 600 nm) in the thickness direction of a cured product with a thickness of 100 μm formed by curing a composition having the same configuration of the ultraviolet-curable composition of each Example apart from not including a metal powder was 90% or more in all cases.

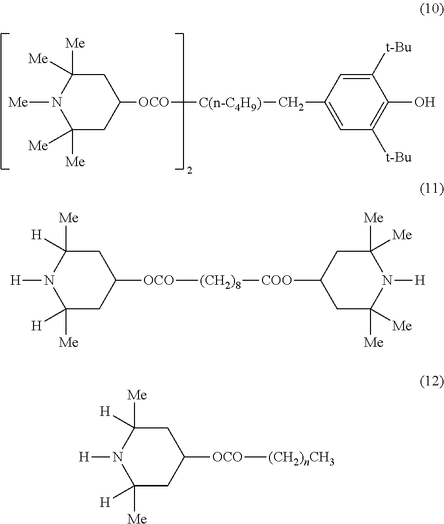

(Here, the substance A shown in Formula (12) is a mixture of a plurality of compounds in which n in the formula is 10 or more to 19 or less (the main component is a compound in which n in the formula is 15 or more to 18 or less).)

TABLE 1

| | Metal powder | | | | | | | |
|---|---|---|---|---|---|---|---|---|
| | | | | Volume | | | | |
| | | Constituent | Material used | average | | | | Average |
| | | material of | in surface | particle | D₁₀ | D₉₀ | Half-value | thickness |
| | Shape | base particles | treatment | diameter [μm] | [μm] | [μm] | width [μm] | [nm] |
| Example 1 | Flaky | Al | FAP1 | 0.45 | 0.28 | 0.77 | 0.32 | 25 |
| Example 2 | Flaky | Al | FAP1 | 0.45 | 0.28 | 0.77 | 0.32 | 25 |
| Example 3 | Flaky | Al | FAP1 | 0.45 | 0.28 | 0.77 | 0.32 | 25 |
| Example 4 | Flaky | Al | FAP1 | 0.75 | 0.43 | 1.33 | 0.84 | 20 |
| Example 5 | Flaky | Al | LAP | 0.95 | 0.51 | 1.75 | 1.12 | 80 |
| Example 6 | Flaky | Al | FAP1 | 0.78 | 0.42 | 1.32 | 0.85 | 50 |
| Example 7 | Flaky | Al | FAP1 | 0.78 | 0.42 | 1.32 | 0.85 | 50 |
| Example 8 | Flaky | Al | FAP1 | 0.45 | 0.28 | 0.77 | 0.32 | 15 |
| Example 9 | Flaky | Al | FAS1 | 0.46 | 0.28 | 0.78 | 0.32 | 20 |
| Example 10 | Flaky | Al | FAS2 | 0.48 | 0.29 | 0.82 | 0.32 | 20 |
| Example 11 | Flaky | Al | FAP1 | 0.66 | 0.39 | 1.18 | 0.64 | 30 |
| Example 12 | Flaky | Al | FAP1 | 0.69 | 0.41 | 1.13 | 0.77 | 30 |
| Example 13 | Flaky | Al | FAP1 | 0.63 | 0.38 | 1.19 | 0.63 | 20 |
| Example 14 | Flaky | Al | LEP | 0.42 | 0.25 | 0.68 | 0.30 | 13 |
| Example 15 | Flaky | Ni49.5Fe50.5 | FAS1 | 1.35 | 0.74 | 2.16 | 0.96 | 30 |
| Example 16 | Flaky | SUS316L | FAS2 | 1.65 | 0.89 | 2.58 | 1.23 | 40 |
| Example 17 | Flaky | Al | OTS | 2.16 | 1.18 | 3.51 | 1.91 | 15 |
| Example 18 | Flaky | Al | FFA1 | 0.52 | 0.32 | 0.86 | 0.33 | 20 |
| Example 19 | Flaky | Al | IS1 | 0.46 | 0.28 | 0.78 | 0.32 | 20 |
| Example 20 | Flaky | Al | AP1 | 0.46 | 0.28 | 0.78 | 0.32 | 20 |
| Comparative | Flaky | Al | FAP1 | 0.45 | 0.28 | 0.77 | 0.32 | 25 |
| Example 1 | | | | | | | | |
| Comparative | Flaky | Al | FAP1 | 0.45 | 0.28 | 0.77 | 0.32 | 25 |
| Example 2 | | | | | | | | |
| Comparative | Flaky | Al | FAP1 | 0.58 | 0.42 | 1.13 | 0.55 | — |
| Example 3 | | | | | | | | |

| | Fluorine-containing powder | | | | | |
|---|---|---|---|---|---|---|
| | | | | | | Volume |
| | | | Constituent | Constituent | Surface | average |
| | | Dendritic | material of | material of | free energy | particle |
| | Shape | polymer | core | dendron | (mN/m) | diameter [nm] |
| Example 1 | Sphere | FA200 | — | — | 19 | 7.5 |
| Example 2 | Sphere | FA50 | — | — | 22 | 7.5 |
| Example 3 | Sphere | FA-1 | Acryl | Acryl | 22 | 15 |
| Example 4 | Sphere | FA200 | — | — | 19 | 7.5 |
| Example 5 | Sphere | FA200 | — | — | 19 | 7.5 |
| Example 6 | Sphere | FA200 | — | — | 19 | 7.5 |
| Example 7 | Sphere | FA-1 | — | — | 22 | 15 |
| Example 8 | Sphere | FA50 | — | — | 22 | 7.5 |
| Example 9 | Sphere | FA50 | — | — | 22 | 7.5 |
| Example 10 | Sphere | FH1 | — | — | 19 | 10 |
| Example 11 | Sphere | FH1 | — | — | 19 | 10 |
| Example 12 | Sphere | FX | — | — | 19 | 13 |
| Example 13 | Sphere | FX | — | — | 19 | 13 |
| Example 14 | Sphere | FA-1 | Acryl | Acryl | 19 | 15 |
| Example 15 | Sphere | FE-1 | Epoxy | Epoxy | 27 | 20 |
| Example 16 | Sphere | FA200 | — | — | 19 | 7.5 |
| Example 17 | Sphere | FA-1 | Acryl | Acryl | 19 | 15 |
| Example 18 | Sphere | FE-1 | Epoxy | Epoxy | 27 | 20 |
| Example 19 | Sphere | FA200 | — | — | 19 | 7.5 |
| Example 20 | Sphere | FA50 | — | — | 22 | 7.5 |
| Comparative | — | — | — | — | — | — |
| Example 1 | | | | | | |
| Comparative | Sphere | Non-dendritic | PTFE | — | 19 | 40 |
| Example 2 | | polymer | | | | |
| Comparative | Sphere | FA200 | — | — | 19 | 7.5 |
| Example 3 | | | | | | |

TABLE 2

| | | Fluorine- | | | | |
|---|---|---|---|---|---|---|
| | | containing | | | Dispersing | |
| | Metal powder | powder | | | agent/defoaming agent | |
| | Content ratio | Content ratio | Polymerizable compound | | | Content ratio |
| | [parts by | [parts by | | Content ratio [parts by | | [parts by |
| | mass] | mass] | | mass] | | mass] |
| Example 1 | 1.5 | 1.0 | AMO/BA/THFA | 50.4/20.0/15.9 | D1/D354 | 0.5/0.1 |
| Example 2 | 1.5 | 1.0 | AMO/BA/THFA | 41.8/22.0/22.0 | D1/B3441 | 0.5/0.1 |
| Example 3 | 3.0 | 2.0 | AMO/BA/THFA | 31.1/33.0/ | D1/D354 | 0.5/0.2 |
| | | | | 19.5 | | |
| Example 4 | 2.0 | 1.0 | BLA/THFM/ | 36.6/10.0/ | D2/D354 | 0.5/0.2 |
| | | | TAOEI/DCPTeOEA/ | 15.8/10.8/ | | |
| | | | AA/PEA/DPGDA | 5.4/3.9/3.9 | | |
| Example 5 | 1.3 | 1.2 | AM/PMPM/TMPM/ | 3.8/7.8/3.0/ | D2/D354 | 0.5/0.2 |
| | | | MAM/EAM/DCPTeA/ | 3.0/3.1/3.8/ | | |
| | | | BA/TPGDA/VEEA | 58.2/1.2/2.0 | | |
| Example 6 | 5.0 | 3.0 | DCPTeOEM/MLM/ | 3.4/3.4/ | D2/D392 | 0.3/0.1 |
| | | | DMTCDDA/AMO/ | 3.1/44.8/ | | |
| | | | IBA/CHM/PEA/HPPA | 4.9/8.0/8.0/4.9 | | |
| Example 7 | 2.0 | 1.0 | DMDCPTA/DCPTeM/ | 2.7/4.5/ | D1/D392 | 0.3/0.1 |
| | | | DCPTaM/IBM/CHA/ | 4.1/5.9/2.5/ | | |
| | | | PEA/BA/AMO | 4.1/16.5/45.1 | | |
| Example 8 | 1.5 | 1.0 | AMO/BLA/ | 34.9/29.5/ | D1/B3441 | 0.3/0.2 |
| | | | PEA/THFA/HBA | 9.2/9.1/3.0 | | |
| Example 9 | 1.5 | 1.0 | AMO/BLA/ | 31.9/26.0/7.2/19.8 | D1/B3441 | 0.7/0.2 |
| | | | VC/VP | | | |
| Example 10 | 1.5 | 1.0 | BLA/AMO/ | 26.1/33.0/ | D1/B3441 | 0.3/0.2 |
| | | | TBA/VEEA/UA | 4.8/9.5/12.5 | | |
| Example 11 | 1.5 | 1.0 | BLA/AMO/ | 32.1/33.8/ | D2/B3441 | 1.7/0.2 |
| | | | VP/PEA/BLM | 3.5/13.9/3.0 | | |
| Example 12 | 1.5 | 1.0 | BLA/AMO/ | 24.7/24.6/ | D3/B3441 | 0.3/0.2 |
| | | | VEEA/BM/UA | 14.2/16.3/10.3 | | |

| | Substance A | | | |
|---|---|---|---|---|
| | | Content ratio | Other components | |
| | | [parts by | | Content ratio |
| | | mass] | | [parts by mass] |
| Example 1 | A1 | 0.2 | ic819/scTPO/ | 4.0/4.0/ |
| | | | scDETX/LF-1 | 1.0/1.0 |
| Example 2 | A2 | 0.3 | ic819/scTPO/ | 4.0/4.0/ |
| | | | scDETX/LHP/LF-2 | 2.0/0.2/0.2 |
| Example 3 | A1 | 0.5 | ic819/scTPO/ | 4.0/4.0/ |
| | | | scDETX/LF-1 | 2.0/0.2 |
| Example 4 | A3 | 0.7 | ic819/scTPO/ | 4.0/4.0/ |
| | | | scDETX/LF-1 | 1.2/0.2 |
| Example 5 | A4 | 1.2 | ic819/scTPO/ | 4.0/4.0/ |
| | | | scDETX/LHP/LF-2 | 2.0/0.2/0.2 |
| Example 6 | A1 | 0.5 | ic819/scTPO/ | 4.0/4.0/ |
| | | | scDETX/LHP/LF-2 | 2.0/0.2/0.2 |
| Example 7 | A1 | 0.6 | ic819/scTPO/ | 4.0/4.0/ |
| | | | scDETX/BY350 | 1.0/1.0 |
| Example 8 | A2 | 0.8 | ic819/scTPO/ | 4.0/4.0/ |
| | | | scDETX/LHP/LF-2 | 2.0/0.2/0.2 |
| Example 9 | A1 | 1.4 | ic819/scTPO/ | 4.0/4.0/ |
| | | | scDETX/LF-1 | 2.0/0.2 |
| Example 10 | A1 | 0.4 | ic819/scTPO/ | 4.0/4.0/ |
| | | | scDETX/LHP/LF-2 | 2.0/0.2/0.2 |
| Example 11 | A3 | 0.8 | ic819/scTPO/LHP/MEHQ | 4.0/4.0/ |
| | | | | 0.2/0.2 |
| Example 12 | A1 | 0.2 | ic819/scTP0/ | 4.0/2.0/ |
| | | | LF-1/MEHQ | 0.2/0.2 |

TABLE 3

| | | Fluorine- | | | Dispersing | |
|---|---|---|---|---|---|---|
| | | containing | | | agent/defoaming agent | |
| | Metal powder | powder | Polymerizable compound | | | Content ratio |
| | Content ratio | Content ratio | | Content ratio | | [parts by |
| | [parts by mass] | [parts by mass] | | [parts by mass] | | mass] |
| Example 13 | 2.0 | 1.0 | AMO/BA/ | 33.3/31.7/20.1 | —/D354 | —/0.3 |
| | | | PEA | | | |
| Example 14 | 2.0 | 1.0 | AMO/BA/ | 30.5/29.0 7.6/7.1/ | —/D354 | —/0.3 |
| | | | ECA/MTEGA/ | 2.7/2.9/5.5 | | |
| | | | DAI/TAI/IBA | | | |
| Example 15 | 2.0 | 1.0 | AMO/BA/ | 30.3/29.2/ | D1/B3441 | 0.3/0.2 |
| | | | TBA/VEEA/UA | 11.6/10.2/4.0 | | |
| Example 16 | 2.0 | 1.5 | AMO/BA/ | 33.5/27.0/ | D1/D354 | 0.3/0.2 |
| | | | VEEA/BM/MEDOLA | 10.8/10.3/4.0 | | |
| Example 17 | 2.5 | 0.2 | AMO/THFA | 51.4/34.7 | D1/D354 | 0.3/0.2 |
| Example 18 | 1.5 | 1.0 | AMO/BA/THFA | 39.6/39.5/6.9 | D1/B3441 | 0.3/0.2 |
| Example 19 | 5.0 | 1.0 | AMO/BA/DCPTaA/ | 27.4/26.5/ | D1/B3441 | 0.3/0.2 |
| | | | CHDOLA | 12.3/16.3 | | |
| Example 20 | 1.5 | 1.0 | AMO/BA | 51.5/33.6 | D1/D354 | 0.3/0.2 |
| Comparative | 1.5 | — | AMO/BA/THFA | 50.8/20.0/16.9 | D1/D354 | 0.5/0.1 |
| Example 1 | | | | | | |
| Comparative | 1.5 | 1.0 | AMO/BA/THFA | 50.8/20.0/15.9 | D1/D354 | 0.5/0.1 |
| Example 2 | | | | | | |
| Comparative | 1.5 | 1.0 | — | — | — | — |
| Example 3 | | | | | | |

| | Substance A | | | |
|---|---|---|---|---|
| | | Content ratio | Other components | |
| | | [parts by | | Content ratio |
| | | mass] | | [parts by mass] |
| Example 13 | A4 | 1.2 | ic819/scTPO/ | 4.0/4.0/ |
| | | | scDETX/LHP/LF-2 | 2.0/0.2/0.2 |
| Example 14 | A1 | 1.0 | ic819/scTPO/ | 4.0/4.0/ |
| | | | scDETX/LHP/LF-2 | 2.0/0.2/0.2 |
| Example 15 | A2 | 0.8 | ic819/scTPO/ | 4.0/4.0/ |
| | | | scDETX/LHP/LF-2 | 2.0/0.2/0.2 |
| Example 16 | A1 | 0.2 | ic819/scTPO/ | 4.0/4.0/ |
| | | | scDETX/LF-1 | 2.0/0.2 |
| Example 17 | A2 | 0.3 | ic819/scTPO/ | 4.0/4.0/ |
| | | | scDETX/LHP/LF-2 | 2.0/0.2/0.2 |
| Example 18 | A2 | 0.6 | ic819/scTPO/ | 4.0/4.0/ |
| | | | scDETX/LHP/LF-2 | 2.0/0.2/0.2 |
| Example 19 | A2 | 0.6 | ic819/scTPO/ | 4.0/4.0/ |
| | | | scDETX/BY350/LF-1 | 2.0/0.2/0.2 |
| Example 20 | A1 | 1.0 | ic819/scTPO/ | 4.0/4.0/ |
| | | | scDETX/LHP/LF-2 | 2.0/0.2/0.2 |
| Comparative | A1 | 0.2 | ic819/scTPO/ | 4.0/4.0/ |
| Example 1 | | | scDETX/LF-1 | 1.0/1.0 |
| Comparative | A1 | 0.2 | ic819/scTPO/ | 4.0/4.0/ |
| Example 2 | | | scDETX/LF-1 | 1.0/1.0 |
| Comparative | — | — | Water/1,2 | 69.1/3.0/14.0/ |
| Example 3 | | | HD/TMP/S465/TFA/GL/PF401 | 1.5/0.3/9.0/0.1 |

### 2. Liquid Discharge Stability Evaluation (Discharge Stability Evaluation)

Using the composition for producing the recorded matter (the ultraviolet-curable composition) of each Example and Comparative Example, evaluation was carried out according to the tests described below.

Firstly, the liquid droplet discharging apparatus installed in a chamber (thermal chamber) and the composition for producing the recorded matter (the ultraviolet-curable composition) in each of the Examples and Comparative Examples were prepared, in a state where driving waveforms of piezoelectric elements are optimized, and in an environment of 25° C. and 50% RH, a discharge average speed of the liquid droplets and the weight of ink for each of the compositions for producing the recorded matter (the ultraviolet-curable composition) were measured beforehand while carrying out continuous discharge at a frequency of 20 kHz from each nozzle of a liquid droplet discharging head of which the size of the nozzle hole has a diameter of 22 μm. Next, the situation when continuous discharge of 1,000,000 liquid droplets (1,000,000 droplets) from each nozzle was performed was taken in to a computer as an imaging image and the defective nozzles (the total number of nozzles which did not normally discharge such as discharge speed decreases or the like which accompanies omissions, discharge bending, ink weight changes, and the like) were acquired and counted. The omissions in this case indicate a state where the liquid droplets did not come out from the nozzle holes or abnormal emissions were caused in a spray form and also the discharge bending indicates a state of flying bending in a range of ±5 degrees or more with respect to a normal state where discharge is carried out in the normal direction of a nozzle surface. For the reduction of the discharge speed, a nozzle is calculated as a defective nozzle when the speed is reduced by 3% or more with respect to the discharge average speed calculated beforehand. When the probability of the generation (the ratio of defect nozzles with respect to the total number of evaluated nozzles) of defective nozzles is small, the discharge stability can be determined as high.

### 2.1 Bending Failure Generation Rate

A: Bending failure generation probability is less than 0.5%
B: Bending failure generation probability is 0.5% or more and less than 1.0%
C: Bending failure generation probability is 1.0% or more and less than 5.0%
D: Bending failure generation probability is 5.0% or more and less than 10.0%
E: Bending failure generation probability is 10.0% or more

### 2.2 Omission Failure Generation Ratio (Discharge Omission)

A: Omission failure generation probability is less than 0.5%
B: Omission failure generation probability is 0.5% or more and less than 1.0%
C: Omission failure generation probability is 1.0% or more and less than 2.0%
D: Omission failure generation probability is 2.0% or more and less than 5.0%
E: Omission failure generation probability is 5.0% or more

### 3. Storage Stability Evaluation (Long-Term Stability Evaluation) of Composition for Producing Recorded Matter

### 3.1 Dispersibility

The composition for producing the recorded matter (the ultraviolet-curable composition) in each Example and Comparative Example, were left in an environment of 40° C. for days, then 1 L thereof was passed through a capsule filter (manufactured by Yamashin-Filter Corp.) with a filtration precision of 3 μm, the mass concentrations of the metal powder in the composition for producing the recorded matter (the ultraviolet-curable composition) before and after the passing were measured, the loss due to the filtering of rough particles caused by insufficient dispersion was determined using the mass concentration reduction ratio, and evaluation thereof was carried out according to the criteria below.
A: Ink concentration reduction ratio is less than 5%
B: Ink concentration reduction ratio is 5% or more and less than 10%
C: Ink concentration reduction ratio is 10% or more and less than 20%
D: Ink concentration reduction ratio is 20% or more

### 3.2 Increase Ratio of Viscosity

The compositions for producing the recorded matter (the ultraviolet-curable composition) in each Example and Comparative Example were left in an environment of 60° C. for 20 days, then the viscosity at 20° C. of the compositions for producing the recorded matter (the ultraviolet-curable composition) in each Example measured on the basis of JIS Z8809 was measured using a vibration-type viscometer, the increase ratio of the viscosity directly after being produced was determined, and evaluation thereof was carried out according to the criteria below.
A: Viscosity increase ratio is less than 5%
B: Viscosity increase ratio is 5% or more and less than 10%
C: Viscosity increase ratio is 10% or more and less than 18%
D: Viscosity increase ratio is 18% or more and less than 23%
E: Viscosity increase ratio is 23% or more, or generation of foreign matter is confirmed.

### 4. Curability

The compositions for producing the recorded matter (the ultraviolet-curable composition) of each of the Examples and Comparative Examples were introduced into a printer, PM800C, manufactured by Epson, solid printing was performed with a wet ink amount of 9 g/m² using Diafoil G440E (thickness 38 μm) produced by Mitsubishi Plastics, Inc. as a recording medium, the result was irradiated with ultraviolet light immediately after printing using an LED-UV lamp, RX firefly (gap 6 mm peak wavelength 395 nm 1000 mW/cm²) manufactured by Foseon Co., Ltd., it was confirmed whether or not the composition for producing the recorded matter (the ultraviolet-curable composition) was cured, and evaluation was performed in accordance with the following five stages of criteria. Whether or not the composition is cured is determined by whether or not the uncured ink composition is attached or not after rubbing the surface with a cotton swab. Here, which of A to E below the irradiation amount corresponds to can be calculated according to the number of seconds of irradiation with the lamp.
A: Cured with an ultraviolet irradiation amount of less than 200 mJ/cm²
B: Cured with an ultraviolet irradiation amount of 200 mJ/cm² or more and less than 350 mJ/cm²
C: Cured with an ultraviolet irradiation amount of 350 mJ/cm² or more and less than 500 mJ/cm²
D: Cured with an ultraviolet irradiation amount of 500 mJ/cm² or more and less than 1000 mJ/cm²
E: Cured with an ultraviolet irradiation amount of 1000 mJ/cm² or more. Or not cured at all.

### 5. Producing Recorded Matter

Using the compositions for producing the recorded matter (the ultraviolet-curable composition) in each Example and Comparative Example, interior panels were respectively produced as the recorded matter as described below.

Firstly, the compositions for producing the recorded matter (the ultraviolet-curable composition) were inserted in an ink jet apparatus.

After that, the composition for producing the recorded matter (the ultraviolet-curable composition) was discharged onto a substrate (a recording medium) which had a curved surface section formed using polycarbonate (produced by Asahi Glass Co., Ltd., carbo glass, polish, 2 mm thickness) in a predetermined pattern, irradiated with ultraviolet rays with a spectrum which had maximum values in wavelength of 365 nm, 380 nm, and 395 nm at an irradiation intensity of 160 mW/cm² for 10 seconds and the compositions for producing the recorded matter (the ultraviolet-curable composition) on the substrate were cured. After that, heating was carried out at 80° C. for one hour and interior panels were obtained as the recorded matter.

Using the method described above, each of 10 interior panels (recorded matter) was produced using the compositions for producing the recorded matter (the ultraviolet-curable composition) in each Example and Comparative Example.

In addition, 10 interior panels (recorded matter) were each produced using the composition for producing the recorded matter (the ultraviolet-curable composition) in each Example and Comparative Example in the same manner as described above apart from using a substrate formed using polyethylene terephthalate (produced by Mitsubishi Plastics Inc., Diafoil G440E, 38 μm thickness), a substrate formed using a low density polyethylene (produced by Mitsui Chemicals Tohcello. Inc., T.U.X (L-LDPE) HC-E #80), a substrate formed using biaxial-stretched polypropylene (produced by Mitsui Chemicals Tohcello. Inc., OP U-1 #60), and a substrate formed using hard vinyl chloride (produced by Acrysunday Co., Ltd. Sunday sheet (transparent), 0.5 mm thickness) as the substrate.

### 6. Evaluation of Recorded Matter

Each recorded matter which was obtained as described above was evaluated as follows.

### 6.1 Appearance Evaluation of Recorded Matter

Each recorded matter which was produced in each Example and Comparative Example was visually observed and evaluated according to the criteria of the 7 stages below.
A: Having glossiness with a full sense of luxury and having an extremely excellent appearance
B: Having glossiness with a full sense of luxury and having a very excellent appearance
C: Having glossiness with a full sense of luxury and having an excellent appearance
D: Having glossiness with a full sense of luxury and having a favorable appearance
E: Glossiness is poor and the appearance is slightly defective
F: Glossiness is poor and the appearance is defective
G: Glossiness is poor and the appearance is extremely defective

### 6.2 Glossiness Level

For the pattern forming portion of each recorded matter produced in each Example and Comparative Example, the glossiness level at a flap angle of 60° was measured using a gloss meter (MINOLTA MULTI GLOSS 268) and evaluated according to the criteria below.
A: Glossiness level is 320 or more
B: Glossiness level is 250 or more and less than 320
C: Glossiness level is 150 or more and less than 250
D: Glossiness level is less than 150

### 6.3 Abrasion Resistance

On the basis of JIS L0849, 48 hours after producing the recorded matter, loads of 500 g of the recorded matter according to each Example and Comparative Example were mounted in a fastness test apparatus and cloth rubbing was performed thereon 30 times, the glossiness level (at a flap angle 60°) of the recorded matter after the cloth rubbing was also measured with the same method as the description 6.2. described above, the decrease ratio of the glossiness level before and after the cloth rubbing was obtained, and evaluation thereof was carried out according to the criteria below.
A: Glossiness level decrease ratio is less than 10%
B: Glossiness level decrease ratio is 10% or more and less than 20%
C: Glossiness level decrease ratio is 20% or more and less than 30%
D: Glossiness level decrease ratio is 30% or more and less than 50%
E: Glossiness level decrease ratio is 50% or more

The results are shown in Table 4. Here, in Table 4, the recorded matter produced using a substrate made of polycarbonate is shown as “M1”, the recorded matter produced using a substrate made of polyethylene terephthalate as “M2”, the recorded matter produced using a substrate made of low density polyethylene as “M3”, the recorded matter produced using a substrate made of biaxial-stretched polypropylene as “M4”, and the recorded matter produced using a substrate made of hard vinyl chloride as “M5”.

TABLE 4

| | | | Long-term stability | | | | | | | | | | | | | | | | | |
|---|---|---|---|---|---|---|---|---|---|---|---|---|---|---|---|---|---|---|---|---|
| | | | | Viscosity | | Appearance of | | | | | | | | | | | | | | |
| | Discharge | Discharge | | increase | | recorded matter | | | | | Glossiness | | | | | Abrasion resistance | | | | |
| | bending | omissions | Dispersibility | ratio | Curability | M1 | M2 | M3 | M4 | M5 | M1 | M2 | M3 | M4 | M5 | M1 | M2 | M3 | M4 | M5 |
| Example 1 | A | A | A | A | A | A | A | B | B | A | A | A | A | A | A | B | B | B | B | B |
| Example 2 | A | A | A | A | A | A | A | A | B | A | A | A | A | B | A | B | B | B | B | B |
| Example 3 | B | B | A | A | A | A | A | B | B | A | A | B | C | B | A | B | B | B | B | B |
| Example 4 | C | C | A | B | A | A | B | B | B | A | B | C | C | C | B | A | A | B | B | A |
| Example 5 | B | C | C | B | D | B | B | B | B | A | C | C | C | C | B | B | C | C | C | C |
| Example 6 | B | C | C | B | C | B | B | B | C | B | C | C | C | C | C | A | B | B | C | A |
| Example 7 | B | C | C | B | B | A | B | B | C | B | C | C | C | C | C | A | B | B | B | A |
| Example 8 | A | B | A | B | B | A | B | B | C | B | B | B | B | C | B | A | B | B | C | B |
| Example 9 | A | A | A | C | C | B | B | C | B | B | A | A | A | A | A | B | B | C | C | B |
| Example 10 | A | B | A | B | B | B | B | B | B | B | B | B | C | C | B | B | B | B | B | B |
| Example 11 | A | B | A | C | B | B | B | B | B | B | B | B | B | B | B | B | B | B | C | B |
| Example 12 | A | A | A | A | C | B | B | B | C | B | B | B | B | B | B | B | B | B | C | B |
| Example 13 | B | A | B | B | A | B | B | C | C | B | A | A | A | A | A | B | B | B | C | B |
| Example 14 | A | A | B | B | C | B | B | C | B | B | C | B | C | C | B | B | B | B | B | B |
| Example 15 | C | C | C | B | A | A | A | B | C | B | B | B | B | C | B | B | B | B | B | B |
| Example 16 | C | C | C | A | C | B | B | C | C | B | B | B | C | C | B | A | B | B | C | B |
| Example 17 | C | C | B | B | A | B | B | C | C | C | A | B | B | B | A | B | B | B | C | B |
| Example 18 | B | B | A | A | A | A | A | A | A | A | A | A | A | B | A | B | B | B | C | B |
| Example 19 | C | C | A | A | A | A | A | A | A | A | A | A | B | B | B | A | A | B | B | A |
| Example 20 | A | A | A | A | A | A | A | A | A | A | A | A | B | B | A | B | B | B | C | B |
| Comparative | C | D | A | A | A | C | C | E | E | D | B | B | C | C | B | B | B | D | D | B |
| Example 1 | | | | | | | | | | | | | | | | | | | | |
| Comparative | B | C | A | A | A | B | C | D | E | D | B | A | C | C | B | B | B | D | D | B |
| Example 2 | | | | | | | | | | | | | | | | | | | | |
| Comparative | E | E | D | B | A | E | F | G | G | E | D | D | D | D | D | B | B | D | D | B |
| Example 3 | | | | | | | | | | | | | | | | | | | | |

As is clear from Table 4, the composition (the ultraviolet-curable composition) of the invention is excellent in the liquid droplet discharge stability, storage stability, and curability. In addition, the recorded matter of the invention has excellent glossiness and appearance and is also excellent in the abrasion resistance of the pattern forming portion. In addition, by using the composition (the ultraviolet-curable composition) of the invention, excellent results were stably obtained regardless of the type of the recording medium. In contrast, satisfactory results were not obtained with the Comparative Examples.

The entire disclosure of Japanese Patent Application No. 2015-224704, filed Nov. 17, 2015 is expressly incorporated by reference herein.

What is claimed is:

1. An ultraviolet-curable composition comprising:
a polymerizable compound;
a metal powder; and
a dendritic polymer which contains a fluorine atom.

2. The ultraviolet-curable composition according to claim 1,
wherein an average particle diameter of the dendritic polymer is 2 nm to 20 nm.

3. The ultraviolet-curable composition according to claim 1,
wherein the dendritic polymer has an acrylic skeleton.

4. The ultraviolet-curable composition according to claim 1,
wherein constituent particles of the metal powder are flaky.

5. The ultraviolet-curable composition according to claim 4,
wherein an average thickness of constituent particles of the metal powder is 10 nm to 80 nm.

6. The ultraviolet-curable composition according to claim 4,
wherein an average thickness of the constituent particles of the metal powder is greater than an average particle diameter of the dendritic polymer.

7. The ultraviolet-curable composition according to claim 1,
wherein the average particle diameter of constituent particles of the metal powder is 200 nm to 3.0 μm.

8. The ultraviolet-curable composition according to claim 1,
wherein a monomer having an alicyclic structure is included as the polymerizable compound.

9. The ultraviolet-curable composition according to claim 8,
wherein the monomer having an alicyclic structure includes one type or two or more types selected from a group formed of tris(2-acryloyloxyethyl) isocyanurate, dicyclopentenyloxyethyl acrylate, adamantyl acrylate, γ-butyrolactone acrylate, N-vinyl caprolactam, N-vinylpyrrolidone, pentamethylpiperidyl acrylate, tetramethyl piperidyl acrylate, 2-methyl-2-adamantyl acrylate, 2-ethyl-2-adamantyl acrylate, mevalonate lactone acrylate, dimethylol tricyclodecane diacrylate, dimethylol dicyclopentane diacrylate, dicyclopentenyl acrylate, dicyclopentanyl acrylate, isobornyl acrylate, cyclohexyl acrylate, acryloylmorpholine, tetrahydrofurfuryl acrylate, cyclohexane spiro-2-(1,3-dioxolan-4-yl) methyl acrylate, (2-methyl-2-ethyl-1,3-dioxolan-4-yl) methyl acrylate, and cyclic trimethylolpropane formal acrylate.

10. The ultraviolet-curable composition according to claim 8,
wherein one type or two or more types selected from a group formed of phenoxyethyl acrylate, benzyl acrylate, acrylic acid 2-(2-vinyloxyethoxy) ethyl, dipropylene glycol diacrylate, tripropylene glycol diacrylate, 2-hydroxy 3-phenoxypropyl acrylate, and 4-hydroxybutyl acrylate are included as the polymerizable compound other than the monomer having an alicyclic structure.

11. Recorded matter comprising:
a cured product of the ultraviolet-curable composition according to claim 1; and
a recording medium.

12. Recorded matter comprising:
a cured product of the ultraviolet-curable composition according to claim 2; and
a recording medium.

13. Recorded matter comprising:
a cured product of the ultraviolet-curable composition according to claim 3; and
a recording medium.

14. Recorded matter comprising:
a cured product of the ultraviolet-curable composition according to claim 4; and
a recording medium.

15. Recorded matter comprising:
a cured product of the ultraviolet-curable composition according to claim 5; and
a recording medium.

16. Recorded matter comprising:
a cured product of the ultraviolet-curable composition according to claim 6; and
a recording medium.

17. Recorded matter comprising:
a cured product of the ultraviolet-curable composition according to claim 7; and
a recording medium.

18. Recorded matter comprising:
a cured product of the ultraviolet-curable composition according to claim 8; and
a recording medium.

19. Recorded matter comprising:
a cured product of the ultraviolet-curable composition according to claim 9; and
a recording medium.

20. Recorded matter comprising:
a cured product of the ultraviolet-curable composition according to claim 10; and
a recording medium.
